(19) United States
(12) Patent Application Publication
(10) Pub. No.: US 2021/0024194 A1
(43) Pub. Date: Jan. 28, 2021

(54) VEHICLE NAVIGATION CONTROLLER

(71) Applicant: Fox I. Stephen, Nyack, NY (US)

(72) Inventor: Stephen I Fox, Nyack, NY (US)

(21) Appl. No.: 16/358,515

(22) Filed: Mar. 19, 2019

Related U.S. Application Data
(63) Continuation-in-part of application No. 14/984,142, filed on Feb. 24, 2016, now abandoned.
Application No. 14/984,142 is a continuation-in-part of application No. 14/690,385, filed on Apr. 18, 2015, now Pat. No. 9,643,705.
(60) Provisional application No. 61/981,747, filed on Apr. 19, 2014.

(51) Int. Cl. B63H 25/02; B63H 21/21

(52) U.S. Cl. CPC B63H 25/02; B63H 2025/022; B63H 2025/026; B63H 21/213

(57) ABSTRACT

A navigation controller for a watercraft powered by an engine is comprises a grip member with a facing portion, and a reverse portion opposite the facing portion. The grip member is configured and dimensioned to be gripped by a hand of a user in such a manner that when the user is gripping the grip member, (i) the palm of the hand may engage the facing portion of the grip member, (ii) the tips of one or more of the fingers of the hand, other than the thumb, may simultaneously engage the reverse portion of the grip member and (iii) the thumb of the hand is free to perform another action. A control support is secured to the grip member. The control support has a switch support portion. A plurality of control switches are provided for generating control output signals for controlling at least the speed of the watercraft. The control switches are positioned at points on the switch support portion of the control support. The location of the points allows the user to simultaneously push one of the control switches with the thumb of their hand, while it overlies the facing portion of the grip member. The tips of one or more of the fingers securely grip the grip member while operating one or more of the control switches, with the thumb gripping the grip member.

### CROSS REFERENCE TO RELATED APPLICATIONS

This application is a continuation in part of U.S. patent application Ser. No. 14/984,142 entitled Navigation Controllers for a Vehicle Including Watercraft filed Feb. 24, 2016, which is a continuation in part application of U.S. Utility patent application Ser. No. 14/690,385, filed on Apr. 18, 2015, entitled AN INTEGRATED GRAB BAR AND NAVIGATION CONTROLLER, which is a US Utility patent application of U.S. Provisional Patent Application No. 61/981,747, filed Apr. 19, 2014, entitled AN INTEGRATED GRAB BAR AND NAVIGATION CONTROLLER, the disclosures of which are incorporated herein in their entirety by reference thereto.

### TECHNICAL FIELD

The invention relates to apparatus and methods for the control of a moving vehicle using ergonomically arranged pushbuttons and pushbutton supports, and optionally providing for a steering wheel responsive to rotation by the user in addition to or instead of pushbutton controls.

### STATEMENT REGARDING FEDERALLY SPONSORED RESEARCH OR DEVELOPMENT

(Not applicable)

### BACKGROUND OF THE INVENTION

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion of this section.

A conventional joystick is a user input device that includes a stick that pivots on a base and outputs control signals that indicate the angle and/or direction of the stick. A joystick is also known as the control column and has been the principal control device for many civilian and military aircraft, either as a center stick or side stick. Conventional joysticks are also used for controlling heavy equipment, remote control of unmanned vehicles, wheelchairs, surveillance cameras, and even lawn mowers.

A conventional joystick is typically a two-axis input device, an example of an electronic two-axis joystick was invented at the United States Naval Research Laboratory (NRL) in 1926 (see, for example, U.S. Pat. No. 1,597,416). Most joysticks today are two-dimensional, having two axes of movement, up/down and left/right. A joystick is generally configured so that moving the stick left or right signals movement along the X axis, and moving it forward (up) or back (down) signals movement along the Y axis. The output of a typical analog joystick indicates an angle measure of the movement in any direction in the plane or the space (typically using potentiometers). The output of a typical digital joystick, on the other hand, indicates only on-off signals for four different directions and its mechanically possible combinations (such as up-right or down-left). There are conventional joysticks that also include haptic feedback capability. These joysticks, typically known, for example, as force-feedback joysticks, are active devices, not just input devices. Usually, in the case of a haptic feedback joystick a computer can return a signal to the joystick that causes motors or other mechanisms connected to the stick to resist movement with a returning force or make the joystick vibrate. An example of a force feedback joystick can be found at U.S. Pat. No. 5,742,278.

Conventional joysticks, especially those used for controlling boats on the water, are inherently exposed to high humidity, corrosive and wet environments and need to be waterproof. In particular, the user must be able to utilize the joystick to perform its intended navigational functions, while allowing for freedom to move with or steady against applied force to the watercraft, such as that resulting from a wave or motion of the watercraft.

Inherent in the use of a watercraft is bumping and jostling of the user's body during navigation control of the watercraft. A conventional joystick has the potential for fluid motion in tandem with the user, and requires basic, simple application during stressful situations, such as a storm or choppy waters. Ideally, simultaneously with holding onto the joystick for navigational control, the user should be able to use attached members of the watercraft, such as the walls, for stability. Ideally, the user is able to maintain steady and constant control of the watercraft, while resisting, jostling caused by the motion of the watercraft.

Vehicles are sometimes equipped with a “speed knob” attached to the rim of the steering wheel. The speed knob facilitates faster and easier turning of the steering wheel, and is particularly popular on pleasure boats. The speed knob freely rotates independently of the motion of the steering wheel. A “speed knob” does not have any motor control function. A set of motor controls always occupies a separate location at the helm from the wheel and/or the speed knob, and is manipulated independently of the steering, using the second hand. Speed knobs are attached on a simple spindle to freely rotate. The speed knob only provides a gripping structure that is used to rotate the steering wheel. To control the speed of the watercraft, for example, the user has to take his hand off the steering wheel or speed knob, or use his other hand, to make an adjustment to the throttle that controls the speed of the boat.

### SUMMARY OF THE INVENTION

The present invention is intended to overcome the drawbacks of the prior attempts. In accordance with an exemplary embodiment, a navigation controller for a vehicle comprises a grip member configured and dimensioned to be grabbed by a hand of a user. A mount is provided for mounting the grip member to the steering wheel of the vehicle or mounting the grip member to the dashboard of the vehicle. The grip member is mounted to be engageable by the hand of the user, either for rotating the steering wheel by the user to steer the vehicle or for accessing the removable control member. The control switches generating control output signals for controlling at least the speed of the vehicle. A control plate supports the control switches and is disposed near to the grip member and positioned, configured and dimensioned relative to the grip member to enable a thumb or finger of the user to engage with one or more of the control switches while the hand remains engaged with the grip member. The hand remains engaged with the grip member so that the steering of the vehicle is controlled by rotating the steering wheel through movement of the grip member by the user while simultaneous activation of the control switches by the thumb or finger of hand of the user remains available.

In accordance with exemplary embodiments, a rigidly fixed grip member and control head maintains the necessary spatial relationship between the thumb of the gripping hand and the primary control switches needed for navigation while under weigh, and maintain a strong grip on the grip member and/or control head acting as a grab bar with easy thumb-actuated navigation control regardless of the motion of the vehicle. In the case of a watercraft, in particular, a small watercraft such as a dingy, a waggling joystick is a navigation hazard in a rough seaway whereas the present invention provides convenient thumb controls on a fixed grip to maintain reliable navigation.

In accordance with an embodiment of the present invention, a navigation controller for a watercraft is provided. A force transfer members transfers an applied force to a structural member, such as the floor, transom, engine mount, armrest or other structure member of a watercraft. A mount is rigidly fixed to the force transfer member for transferring applied force to the force transfer member. A grip member and control head are configured and dimensioned to be grabbed by a hand of a user and transfer the force to the mount when affixed to the mount. The grip member is engageable by fingers on the hand of the user for providing a grab bar to the user to resist movement of the body of the user caused by the applied force. The applied force is transferred through the hand of the user to the grip member to the mount to the force transfer member to the structural member to dissipate the applied force in resisting excessive movement of the body of the user caused by applied force. Control switches generate control output signals for controlling the operation of the watercraft. A control plate supports the control switches and is disposed on the control head near to the grip member and positioned, configured and dimensioned relative to the grip member to enable a thumb or finger of the user to engage with one or more of the control switches while the fingers remain engaged with the grip member and/or control head so that the resistance of the applied force to keep the user steady does not cause an unintended activation of one or more of the control switches. A tactile location indicator is disposed on the control plate and provides easy and rapid location indication of the thumb's position relative to the control switches by haptic feedback.

In accordance with another aspect of the invention, a navigation controller for a watercraft is provided comprising a force transfer member for transferring an applied force to a structural member of a watercraft. A mount is rigidly fixed to the force transfer member for transferring the applied force to the force transfer member. A grip member and control head are configured and dimensioned to be grabbed by a hand of a user. The grip member and control head are rigidly mounted to the mount for transferring the applied force to the mount. The grip member and control head are engageable by fingers on the hand of the user for providing a grab bar to the user to resist movement of the body of the user caused by applied force.

For example, the applied force may be caused by the movement of a user's body resulting from a wave or the watercraft taking a sharp turn, and the applied force is applied to the grip member through the arm and the hand of the user and transferred through the mount and through the force transfer member to a structural member, such as the dashboard of the watercraft.

Control switches are provided for generating control output signals for controlling the navigation of the watercraft. A control plate supports the control switches. The control plate is disposed near to the grip member and positioned, configured and dimensioned relative to the grip member to enable a thumb or finger of the user to engage with one or more of the control switches while the fingers remain engaged with the grip member. Unlike a conventional joystick or steering wheel used for navigation control of a vehicle, such as a watercraft, in accordance with the present invention the grip member and control head can be rigidly mounted during operation of the switches so that the resistance of the applied force to keep the user steady does not cause an unintended activation of one or more of the control switches, while the user's grip on the grip member and/or control head is still effective to steady the user against the applied force.

A tactile location indicator disposed on the control plate. The tactile location indicator is positioned on the control plate so that when not activating a control switch, the thumb of the user's hand rests just below the tactile location indicator to facilitate quick locating of a particular control switch by the thumb while the fingers remain engaged with grip member.

In accordance with another aspect of the invention, a navigation controller is provided for a vehicle, such as a watercraft. A force transfer member transfers an applied force to a structural member of a watercraft. A mount is rigidly fixed to the force transfer member. The grip member and control head are configured and dimensioned to be grabbed by a right hand of a user. The grip members are both rigidly mounted to the mount for transferring the applied force to the mount. The grip member and control head are engageable by fingers on the right hand of the user for providing a grab bar to the user to resist movement of the body of the user caused by the applied force. The applied force is transferred through either or both the right hand to the respective grip member to the mount to the force transfer member to the structural member to dissipate the applied force in resisting excessive movement of the body of the user caused by the applied force. Control switches generate control output signals for controlling the navigation of the watercraft. A control plate supports the control switches and is disposed near to the grip member and positioned, configured and dimensioned relative to the grip member to enable a thumb or finger of the user to engage with one or more of the control switches while the fingers remain engaged with the respective grip member. A tactile location indicator is disposed on the control plate to facilitate quick locating of a particular control switch by the thumb while the fingers remain engaged with the grip member.

In accordance with the invention a navigation controller for a watercraft powered by an engine is provided. A grip member has a facing portion, and a reverse portion opposite the facing portion. The grip member is configured and dimensioned to be gripped by a hand of a user in such a manner that when the user is gripping the grip member, (i) the palm of the hand may engage the facing portion of the grip member, (ii) the tips of one or more of the fingers of the hand, other than the thumb, may simultaneously engage the reverse portion of the grip member and (iii) the thumb of the hand is free to perform another action. A control support is secured to the grip member. The control support has a switch support portion. A plurality of control switches are provided for generating control output signals for controlling at least the speed of the watercraft. The control switches are positioned at points on the switch support portion of the control support. The location of the points allows the user to simultaneously push one of the control switches with the thumb of their hand, while it overlies the facing portion of the grip member. The tips of one or more of the fingers engage the reverse portion of the grip member, by which the user may securely grip the grip member while operating one or more of the control switches, with the thumb gripping the grip member.

The navigation controller may further comprise a mount for mounting the grip member to the watercraft with the grip member being mounted to be engageable by the hand of the user. A mount for mounting the grip member to the watercraft may be provided. The grip member may be mounted to be engaged by the hand of the user.

The switch support portion may define a thumb rest support portion. The first of the control switches may be positioned to the left of the thumb rest support portion and a second of the control switches, may be positioned to the right of the thumb rest support portion.

Three additional switches may be disposed on the switch support portion at distances displaced from the grip member greater than the distances at which the first of the control switches is positioned. The second of the control switches may be displaced from the grip member. The three additional switches controlling the engine may operate in forward, reverse and neutral modes.
A first one of the three additional switches may be disposed to the left of the thumb rest support portion. When actuated it puts the engine in reverse mode. The second one of the three additional switches may be disposed to the right of the thumb rest support portion and when actuated puts the engine in forward mode. The third one of the three additional switches may be disposed between the first of the three additional switches and the second. When actuated it puts the engine in neutral mode.

The engine may be an outboard engine, and further may be comprised of two trim switches disposed on the switch support portion at distances displaced from the grip member greater than the distances at which the three additional switches are displaced. The trim switches control the angular position of the outboard engine, allowing it to be rotated into the water to propel the boat or to be rotated out of the water to prevent unnecessary corrosion, particularly in saltwater environments.

One of the speed control switches that causes the engine to increase speed may be displaced further from the grip member than the other speed control switch that causes the engine to decrease speed. The user may thus simultaneously actuate the speed control switch causing the engine to decrease speed while simultaneously actuating the third one of the three additional switches which, when actuated, puts the engine in neutral mode.

The watercraft may have a steering wheel, and the mount for mounting the grip member to the watercraft may be rotatably mounted on the steering wheel.

The control support may have a switch support portion that may be oriented generally transversely to the facing portion.

The first and second of the control switches may be configured to control the speed of the watercraft.

A navigation control may further comprise a mount for mounting the grip member to a steering wheel of the watercraft. The grip member may be rotatably mounted to be engageable by the hand of the user for rotating the steering wheel to steer the watercraft, in the manner of a steering knob on an automobile. The control support supporting the control switches may be positioned below the grip member, so that the steering of the watercraft is controlled by rotating the steering wheel through movement of the grip member by the user, while simultaneous activation of the control switches by the thumb of the same hand may be performed. The control switches rotate with the grip member and remain accessible to the user while allowing a substantially unchanged orientation to the hand of the user during rotation of the steering wheel.

The watercraft may have a steering wheel, and the switch support portion of the control support may be oriented generally transversely to the facing portion.

The control switches may generate control output signals for controlling at least the speed of the watercraft and the direction of the watercraft. The control support may have an exposed switch support portion oriented generally in a plane extending in the same direction as the facing portion.
The control support may have a front side and an opposite side, and may further comprise speed switches positioned on the opposite side of the control support, at positions which allow the index finger of the user to operate the speed switches while (i) the palm of the hand of the user overlies the facing portion of the grip member and (ii) the tips of one or more of the fingers of the hand engage the reverse portion of the grip member.

The first of the control switches and the second of the control switches may be configured to control the direction of the watercraft.

The controller may further comprise a pair of speed control switches positioned on a side of the control support opposite the exposed switch support portion. One of the speed control switches causes the engine to increase speed, and the other causes the engine to decrease speed.

Three additional switches may be disposed on the switch support portion at distances displaced from the grip member greater than the distances at which the first and the second of the control switches are displaced from the grip member. The three additional switches may control the engine to operate in forward, reverse and neutral modes. The first one of the three additional switches may be disposed to the left of the thumb rest support portion and when actuated puts the engine in reverse mode. The second one may be disposed to the right of the thumb rest support portion and when actuated puts the engine in forward mode. The third may be disposed between the first and the second additional switches and when actuated puts the engine in neutral mode. The speed control switches causing the engine to increase speed may be displaced further from the grip member then the other of the speed control switches causing the engine to decrease speed. The user may simultaneously actuate the speed control switch causing the engine to decrease speed while simultaneously actuating the third one of the three additional switches which when actuated puts the engine in neutral mode.

A mount for mounting the grip member to a steering wheel of the watercraft may be comprised of a clamp for removably clamping the grip member, control switches and control plate to the steering wheel.

The grip member may be pivotally mounted on the mount to accommodate an angle of the steering wheel relative to a position of the user.

The mount may include position adjustment means for adjusting at least one of the angle, location and rotation of the grip member.

The control switches include a first set of control switches located on the control plate. The first set of control switches may further comprise at least a throttle up switch and a throttle down switch. The control switches may further include a second set of secondary control switches located on a switch support plate, the second set of control switches including at least one of a forward switch, a neutral switch, a reverse switch, a kill switch and a warm up switch. A navigation controller for a watercraft may feature one or more of the control switches as piezoelectric switches.

A navigation controller for a watercraft may be further comprised of a mount attachable to the steering wheel of the watercraft. The mount may be configured for retrofittably mounting the grip member to the steering wheel so that the grip member may be engaged by the hand of the user for rotating the steering wheel to steer the watercraft. It may also be further comprised of a tactile location indicator positioned on the control plate, so that when not activating the control switch, the thumb or finger of the user can locate and rest on the tactile location indicator to facilitate quick locating of a particular control switch by the thumb or finger while the fingers remain engaged with the grip member and while the fingers and thumb of the hand can develop the full grip on the grip member to provide the resistance to movement. The control switches may rotate with the grip member and remain visible to the user while constantly maintaining maintain a same orientation to the hand.

The control switches may include a first set of control switches located on the control plate. The first set of control switches may comprise at least a throttle up switch and a throttle down switch.

A second set of control switches may be located on a first switch support plate. The second set of control switches may include at least one of a forward switch, a neutral switch, a reverse switch, a kill switch, engine tilt switch and a warm up switch. The first switch support plate is mountable at a location on the steering wheel different from a location of the mount bed, where the control switches supported on the control plate maintain a constant orientation relative to the hand of the user.

A third set of control switches may be located on a second switch support or plate, the third set of control switches including at least one of a forward switch, a neutral switch, a reverse switch, a kill switch, engine tilt switch and a warm up switch, wherein the second switch support plate is mountable at a location on the steering wheel different from the location of the first switch support plate and the location of the mount bed.

The controller may comprise a tactile location indicator positioned on the control support so that when not activating a control switch, the thumb rests on the tactile location indicator to facilitate quick locating of a particular control switch.

The tactile location indicator may include at least one of a textured surface and a vibrator for indicating when a switch has been activated.

The tactile location indicator may include a raised central resting pad.

A navigation controller for a watercraft may have the tactile location indicator positioned on the control plate so that when not activating a control switch, the thumb rests on the tactile location indicator to facilitate quick locating of a particular control switch.

The control support may have a front side and an opposite side, and speed switches positioned on the opposite side of the control support, at positions which allow the index finger of the user to operate the speed switches while (i) the palm of the hand of the user overlies the facing portion of the grip member and (ii) the tips of one or more of the fingers of the hand engage the reverse portion of the grip member.

### BRIEF DESCRIPTION OF THE DRAWINGS

The operation of the inventive will become apparent from the following description taken in conjunction with the drawings, in which:

FIG. 1 is a perspective view of an exemplary embodiment of the inventive integrated grab bar and navigation controller,

FIG. 2 is a side perspective view of an exemplary embodiment;

FIG. 3 is a back perspective view of an exemplary embodiment;

FIG. 4 is a perspective view of an exemplary embodiment;

FIG. 5 is an exploded perspective view of an exemplary embodiment showing a rigidly fixed mounting post disposed on a force transfer member;

FIG. 6 is an exploded perspective view of an exemplary embodiment showing a mounting hole in a grip member for receiving the rigidly fixed mounting post;

FIG. 7 is a perspective view of an exemplary embodiment;

FIG. 8 is a front perspective view of an exemplary embodiment showing a control plate first tier having a parallel second tier switch support plate;

FIG. 9 is a perspective view of an exemplary embodiment showing the control plate first tier having the parallel second tier switch support plate;

FIG. 10 is a front perspective view of an exemplary embodiment showing the control plate first tier having the parallel second tier switch support plate;

FIG. 11 is a perspective view of an exemplary embodiment showing the control plate first tier having the upright second tier switch support plate;

FIG. 12 is a front perspective view of an exemplary embodiment having a pair of grip members and control heads;

FIG. 13 is a back perspective view showing the exemplary embodiment having the pair of grip members and control heads;

FIG. 14 is a perspective view showing the exemplary embodiment having the pair of grip members and control heads;

FIG. 15 is a perspective view of an exemplary embodiment showing a rocker switch for controlling the direction of the vehicle and trigger switches for controlling the speed of the vehicle, with a palm heel rest;

FIG. 16 is a side view of the embodiment shown in FIG. 15;

FIG. 17 is a front view of the embodiment shown in FIG. 15;

FIG. 18 is a front view of the embodiment shown in FIG. 15;

FIG. 19 is a partial perspective view of the embodiment shown in

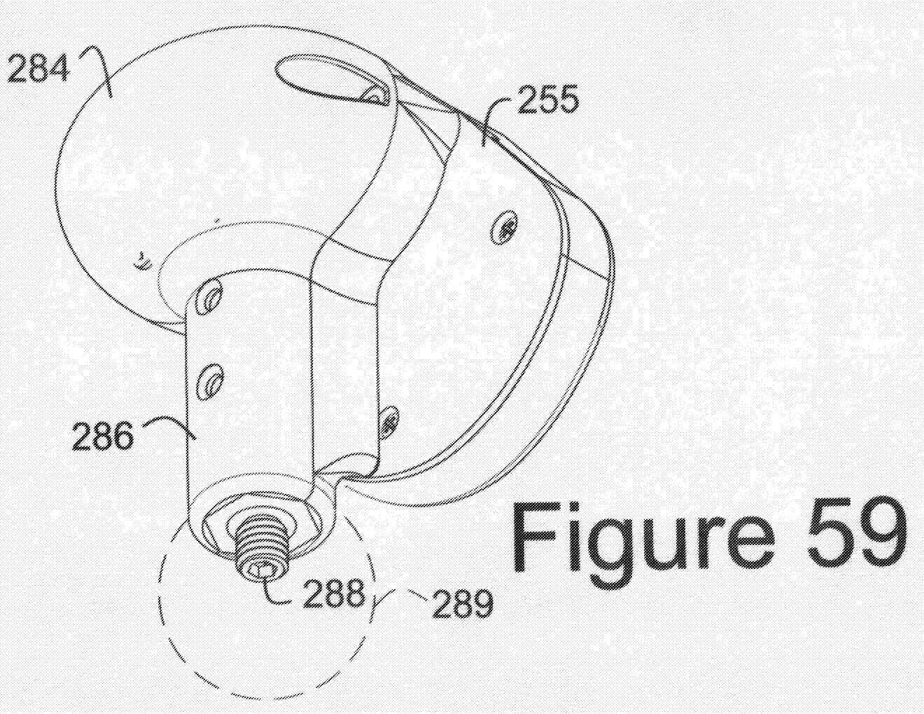

FIG. 18;

FIG. 20 is a side view schematically shows an inventive rocker switch with a tactile indicating resting pad;

FIG. 21 is a top view schematically illustrating the rocker switch shown in FIG. 20;

FIG. 22 is an exploded view schematically illustrating the rocker switch shown in FIG. 20;

FIG. 23 is a side view of another exemplary embodiment;

FIG. 24 is an opposite side view of the embodiment shown in FIG. 23;

FIG. 25 illustrates an exemplary embodiment showing the grip member including a bent tubular member;

FIG. 26 is a perspective view showing the control head positioned at one side of an upside down U shaped bent tubular member;

FIG. 27 is a front view of the embodiment shown in FIG. 26;

FIG. 28 is a perspective view showing dual control heads positioned at either sides of an upside down U shaped bent tubular member;

FIG. 29 is a front view of the embodiment shown in FIG. 28;\

FIG. 30 is an exploded view illustrating an exemplary embodiment of an inventive speed knob navigation controller,

FIG. 31 is an isolated view of a control plate;

FIG. 32 shows a smooth transition knob with a control plate shaft supporting piezo electric speed control switches;

FIG. 33 shows a ball knob with a control plate shaft supporting piezo electric speed control switches;

FIG. 34 shows a flat top knob with a control plate shaft supporting piezo electric speed control switches;

FIG. 35 illustrates a rotationally fixed grip member mounted on a clamping mount;

FIG. 36 illustrates the smooth transition knob grip member rotationally mounted on a clamping mount;

FIG. 37 is an alternative view of the smooth transition knob grip member rotationally mounted on a clamping mount shown in FIG. 36;

FIG. 38 is another alternative view of the smooth transition knob grip member rotationally mounted on a clamping mount shown in FIG. 36;

FIG. 39 illustrates the flat top knob grip member rotationally mounted through the clamping mount to a steering wheel;

FIG. 40 illustrates the smooth transition knob grip member rotationally mounted through the clamping mount to the steering wheel;

FIG. 41 illustrates the ball knob grip member rotationally mounted through the clamping mount to a steering wheel;

FIG. 42 illustrates a steering wheel having a horizontal attitude;

FIG. 43 illustrates a steering wheel having an angled attitude;

FIG. 44 illustrates a steering wheel having a vertical attitude;

FIG. 45 illustrates a steering wheel having a horizontal attitude the ball knob grip member rotationally mounted through the clamping mount to a steering wheel;

FIG. 46 illustrates a steering wheel having an angled attitude the smooth transition knob grip member rotationally mounted through the clamping mount to a steering wheel;

FIG. 47 illustrates a steering wheel having a vertical attitude the flat top knob grip mem FIG. 49 illustrates an alternative aspect of the invention showing a throttle position locking mechanism where steering by wire controls are mounted on conventional outboard shift and throttle controls;

FIG. 49 illustrates an alternative aspect of the invention showing a throttle position locking mechanism where steering by wire controls are mounted on conventional outboard shift and throttle controls;

FIG. 50 shows the throttle position locking mechanism where steering by wire controls are mounted on conventional outboard shift and throttle controls;

FIG. 51 shows a boat throttle arm having right and left steering switches for enabling onehanded control of steering and throttle of a watercraft where steering by wire controls are mounted on conventional outboard shift and throttle controls;

FIG. 52 shows a steering wheel having warmup and tilt actuators, along with a speed knob grip bed, and a hub with a clock spring mechanism for providing a wired connection to the actuators while allowing the wheel to turn; and

FIG. 53 illustrates a rotationally mounted grip member that is configured for being received on a shaft fixed to a mount bed.

FIG. 54 is a front view of inventive navigation controller;

FIG. 55 is a rear view of inventive navigation controller;

FIG. 56 is a front elevational view of inventive navigation controller;

FIG. 57 is a side view of inventive navigation controller;

FIG. 58 is a front elevational view of spinner controller;

FIG. 59 is a rear view of spinner controller; and

FIG. 60 is a side view of spinner controller.

### DETAILED DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated device, and such further applications of the principles of the invention as disclosed herein, as would normally occur to one skilled in the art to which the invention pertains.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

A conventional joystick has a number of drawbacks, especially when used for the operation of a vehicle, such as a watercraft. Inherent in the use of a watercraft is bumping and jostling of the user's body during navigation control of the watercraft. Since a conventional joystick requires the stick to be pivoted during use, it is not effective as a grab bar. Likewise, since a grab bar has to remain rigidly fixed to be effective for steadying a user when resisting an applied force, such as that caused by the movement of a wave on the watercraft, a grab bar is not effective for use as a conventional pivoting joystick. A user has to use his hands to grip a grab bar to steady against an applied external force caused by, for example, a wave hitting the watercraft. Preferably, since the user has only two hands, both hands are available as necessary to hold tight to a grab bar when, for example, a large wave hits. Ideally, simultaneously with holding onto the grab bar that user should be able to control the navigation of the watercraft. Ideally, the user is able to maintain steady and constant control of the watercraft, while resisting jostling caused by the motion of the watercraft. In accordance with exemplary embodiments, a rigidly fixed grip member 12 and control head 14 maintains the necessary spacial relationship between the thumb of the gripping hand and the primary control switches 24 needed for navigation while under weigh, and maintain a strong grip on the grab bar and easy thumb-actuated control regardless of the motion of the vehicle.

Conventional thumb stick switches for joysticks and fixed grip joy sticks are typically designated IP-68. These are designed to be submersible to 1-3 meters (depending on design). These conventional switches are not designed to be exposed in a high pressure water stream, and are typically intended to operate in an outdoor environment. For the IP standards, “waterproof designation” begins with IP-66, only IP69 carries the “waterproof at depth & under high pressure spray”. The use of a conventional waterproof switch that is not designed specifically for water at depth and under high pressure spray will likely fail in the severe conditions of a marine environment, particularly if a small craft were to roll over in a storm or rough seas. In accordance with the inventive integrated grab bar and navigation controller, exemplary embodiments described herein are for use during all phases of regular operation at slow speed, cruising and high speed.

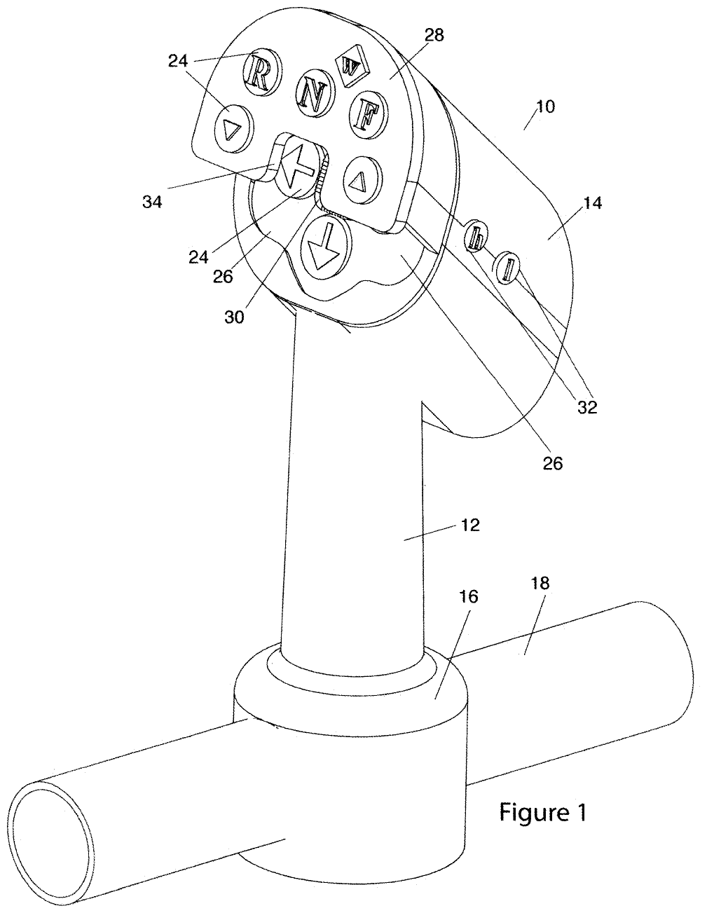

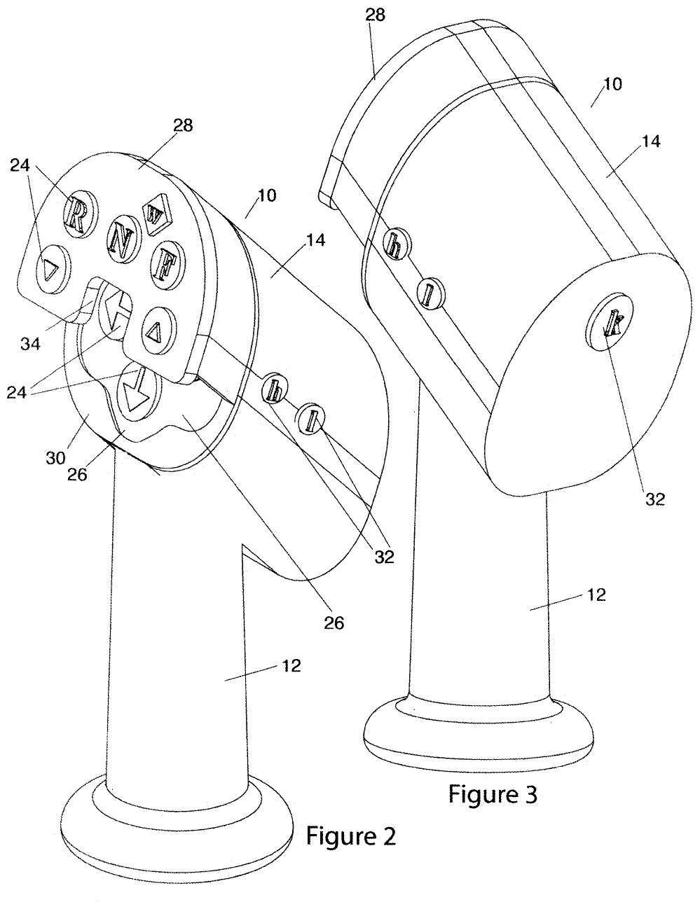

FIG. 1 is a perspective view of an exemplary embodiment of the inventive integrated grab bar and navigation controller 10. FIG. 2 is a side perspective view of an exemplary embodiment. FIG. 3 is a back perspective view of an exemplary embodiment. In accordance with an exemplary embodiment, a navigation controller 10 for a watercraft is provided comprising a force transfer member 18 for transferring an applied force to a structural member of a watercraft. A mount 16 is rigidly fix to the force transfer member 18 for transferring the applied force to the force transfer member 18. A grip member 12 and control head 14 are configured and dimensioned to be grabbed by a hand of a user. The grip member 12 and control head 14 are rigidly mounted to the mount 16 for transferring the applied force to the mount.

A significant advantage of the present invention, having a fixed grip and thumb-controls as compared with the conventional movable joystick, is that the user's ability to fix on the thumb controls location is not disturbed during jostling, because the spacial relationship between the gripping hand and the finger controls is constant, regardless of the motion of the vehicle. In the case of a watercraft, in particular, a small watercraft such as a dingy, a conventional pivoting joystick is a navigation hazard in a rough seaway. In contrast, the inventive integrated grab bar and navigation controller 10 provides effective thumb controls on a fixed grip to maintain reliable navigation control while enabling a robust and steady grab bar to resist unwanted movement of the user's body.

The grip member 12 and control head 14 are engageable by fingers on the hand of the user for providing a grab bar to the user to resist movement of the body of the user caused by the applied force. For example, the applied force may be caused by the movement of a user's body resulting from a wave or the watercraft taking a sharp turn, and the applied force is applied to the grip member 12 through the arm and hand of the user and transferred through the mount 16 and through the force transfer member 18 to a structural members, such as the floor, of the watercraft. The applied force is transferred through the hand of the user to the grip member 12 to the mount 16 to the force transfer member 18 to the structural member to dissipate the applied force in resisting excessive movement of the body of the user caused by the applied force.

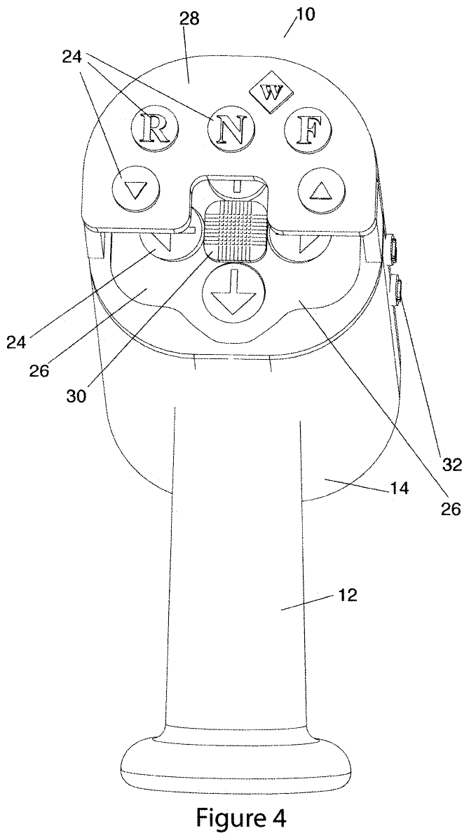

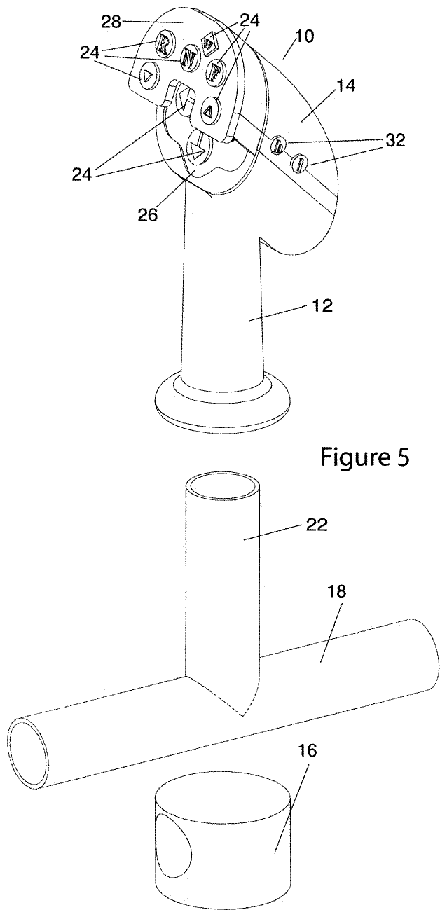

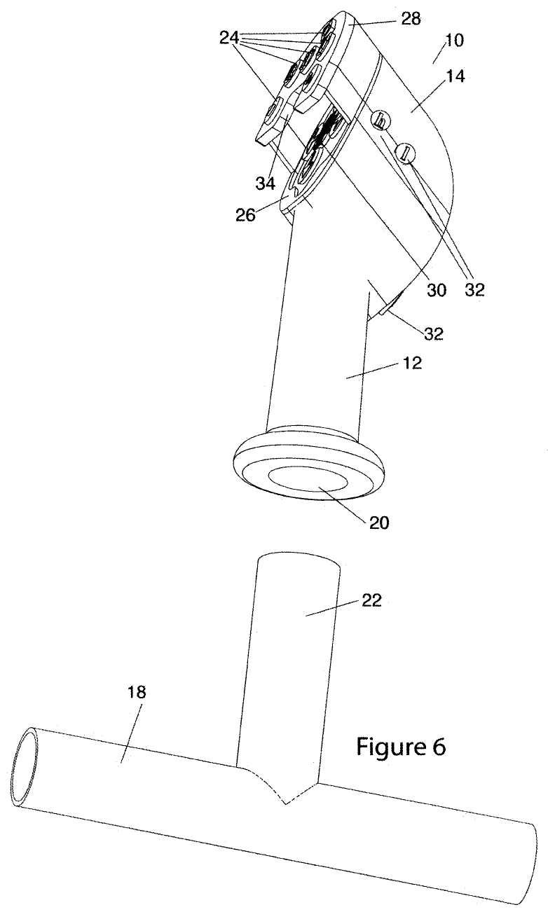

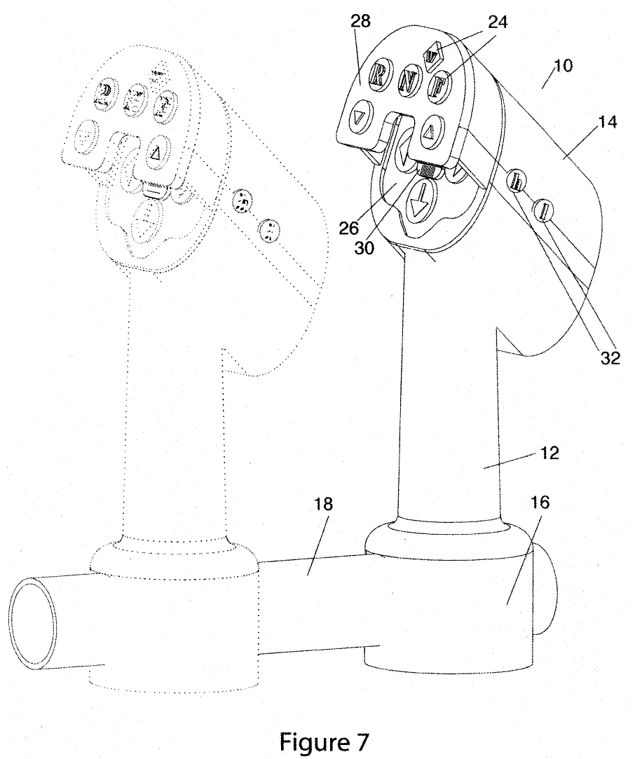

FIG. 4 is a front perspective view of an exemplary embodiment of the inventive integrated grab bar and navigation controller 10. FIG. 5 is an exploded perspective view of an exemplary embodiment showing a rigidly fixed mounting post 22 disposed on a force transfer member 18 and FIG. 6 is an exploded perspective view of an exemplary embodiment showing a mounting hole 20 in a grip member 12 for receiving the rigidly fixed mounting post 22. In accordance with an exemplary embodiment of the inventive integrated grab bar and navigation controller 10, a weatherproof helm control is provided mounted to a rigidly fixed grip member 12. The grip member 12 includes a control head 14 on which is provided a plurality of control switches 24, enabling a one-handed “drive-by-wire” helm for navigation control of, for example, a single engine outboard, or I/O boat without requiring a conventional console or a conventional steering wheel. The “drive-by-wire” helm uses, for example, servo-motors and electronic controllers which may include microprocessors, for electronic control of the navigational aspects of the watercraft, such as steering and throttle, and may also provide electronic control of other aspects of controlling the watercraft such as gear changing, tilt and trim.

In accordance with a non-limiting example, the grip member 12 and control head 14 is fixed to an armrest that acts as a force transfer member 18 for transferring an applied force to a structural member of the watercraft. The watercraft may be, for example, an inflatable boat having a structural member comprising a rigid floor, where the force transfer member 18 transfers the applied force to the floor of the boat. The force transfer member 18 may include a tubular force transfer body with the mount 16 slidably and/or rotationally engaged with the tubular force transfer body to adjust the location of the grip member 12 on the force transfer member 18 during an adjustment process and rigidly fixed to the force transfer member 18 during use of the control switches 24 for controlling the navigation of the watercraft. To accommodate the needs of different users, the mount 16 may include position adjustment means including a releasable clamp for adjusting at least one of the angle, location and rotation of the grip member 12 relative to the force transfer member 18. Alternatively, the force transfer member 18 may be connected to the structure member of the watercraft in a manner that provides for adjusting of the grip member 12 to accommodate the needs of different users.

The grip member 12 may be substantially cylindrical having a longitudinal axis and the control plate 26 may be a substantially planar plate disposed relative to the grip member 12 at a position forming an angle. The adjusting means may be provided to adjust the angle of the control plate 26 relative to the longitudinal axis of the grip member 12. The adjust means may be, for example, a clamp integrated into the mount 16 that allows selective single or multi-axis movement of the grip member 12 relative to the force transfer member. Alternatively or additionally, the adjusting means may include a clamp integrated to the grip member 12 that allows selective single or multi-axis movement of the control head 14 relative to the grip member 12. The mount 16 can be configured to enable movement of the grip member 12 during an adjustment process to adjust of the location of the grip member 12 relative to the force transfer member 18 so that the location of the grip member 12 relative to the body of the user is adjustable during the adjustment process and rigidly fixed to the force transfer member 18 during use of the control switches 24 to control the watercraft.

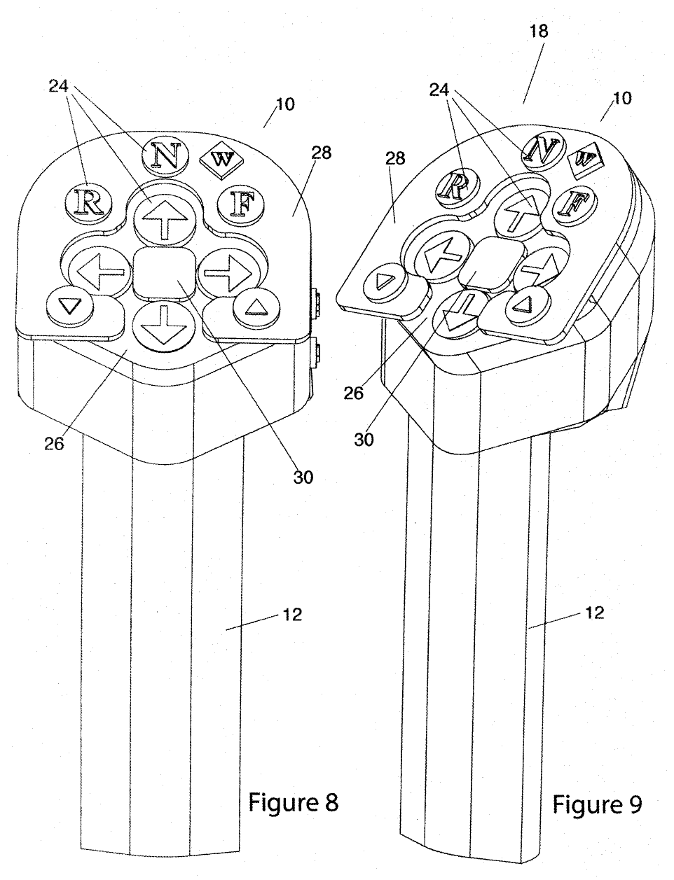

FIG. 8 is a front perspective view of an exemplary embodiment showing a control plate 26 first tier having a parallel second tier switch support plate. FIG. 9 is a perspective view of an exemplary embodiment showing the control plate 26 first tier having the parallel second tier switch support plate. In accordance with an embodiment of the present invention, a fixed grip navigation controller 10 is provided having control switches 24 are arrayed on a control plate 26 and a switch support plate 28, in a 2-tier modular arrangement, in a “frequency of use with critical modalities closest” pattern around the area of reach of the user's thumb. By locating the control switches 24 within an area of reach of the user's thumb, the thumb of the user is able to engage with one or more of the control switches 24 while the fingers remain engaged with the grip member 12, so that the resistance of the applied force to keep the user steady does not cause a unintended activation of one or more of the control switches 24, while the user is able to resist the applied force.

In an exemplary embodiment, the lower tier (the control plate 26), contains a first set of control switches 24 accessible within the area of reach that activate the more frequently accessed and often timing critical control of throttle and steering, arranged, for example, in a diamond pattern around a central tactile location indicator 30 or thumb rest. The top tier (the switch support plate 28) contains a second set of control switches 24 arranged in a horseshoe pattern that activate other navigation control operations such as forward, backward, neutral, trim up, trim down, engine warm up and the like.

The control switches 24 generate control output signals for controlling the navigation of the watercraft. The control plate 26 supports the control switches 24. The control plate 26 is disposed on the control head 14 near to the grip member 12 and positioned, configured and dimensioned relative to the grip member 12 to enable a thumb or finger of the user to engage with one or more of the control switches 24 while the fingers remain engaged with the grip member 12.

A tactile location indicator 30 is disposed on the control plate 26. The tactile location indicator 30 is positioned on the control plate 26 so that when not activating a control switch, the thumb of the user's hand rests on the tactile location indicator 30 to facilitate quick locating of a particular control switch 24 by the thumb while the fingers remain engaged with the grip member 12. The tactile location indicator 30 provides haptic feedback to locate the controls (i.e., the location of the switches). The tactile location indicator 30 may be a textured surface that provides a consistent “home base” position for the thumb of the user, and may include a vibrator to indicate when a switch has been activated.

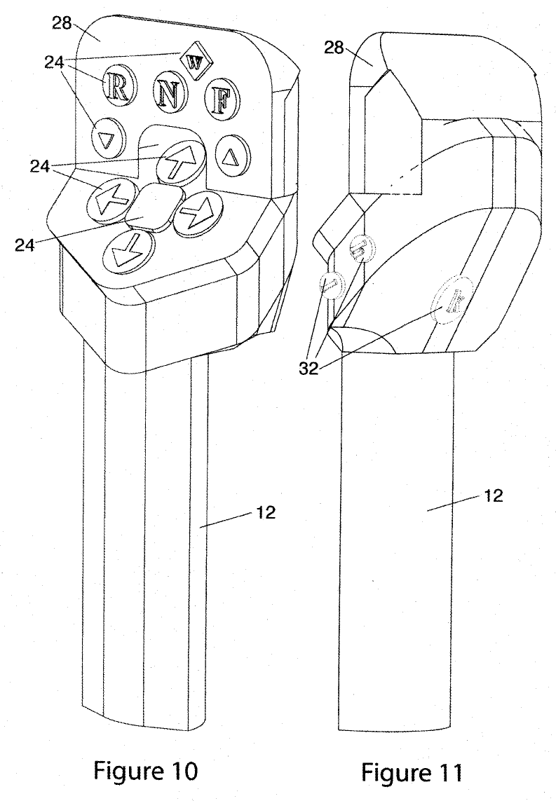

FIG. 10 is a perspective view of an exemplary embodiment showing the control plate 26 first tier having an upright second tier switch support plate. FIG. 11 is a perspective view of an exemplary embodiment showing the control plate 26 first tier having the upright second tier switch support plate. In accordance with one exemplary embodiment, the control switches 24 include a first set of control switches 24 located on the control plate 26. The first set of control switches 24 comprising a throttle up switch, a throttle down switch, a right turn switch and a left turn switch. The control switches 24 may further include a second set of control switches 24 located on a switch support plate 28. The second set of control switches 24 including a forward switch, a neutral switch, a reverse switch. As shown in FIGS. 10 and 11, the switch support plate 28 may be disposed upright relative to the control plate 26. Alternatively, as shown in FIGS. 8 and 9, the switch support plate 28 may be disposed relatively parallel to the control plate 26.

Unlike a conventional joystick or steering wheel used for navigation control of a vehicle, such as a watercraft, in accordance with the present invention the grip member 12 and control head 14 are rigidly fixed. The fingers of the user remain engaged with the grip member 12, and the grip member 12 and control head 14 are rigidly mounted during operation of the switches so that the resistance of the applied force to keep the user steady does not cause a unintended activation of one or more of the control switches 24, while the grip member 12 and control head 14 are still effective to steady the user against the applied force.

The control switches 24 are provided for generating control output signals for controlling the navigation of the watercraft. In addition to the navigation control, ancillary switches 32 may be provided to enable additional control (navigation and otherwise) of the vehicle, such as a watercraft. The ancillary switches 32 can include, for example, hi/lo (fast, slow), kill (emergency stop all), trim/tilt. Note that the ancillary switches 32 may be located differently than shown, for example, the trim/tilt switch (indicated by the up and down arrows) may be located as part of the cluster of control switches 24 disposed on the switch support plate 28.

In accordance with an embodiment of the inventive integrated grab bar and navigation controller 10, a two-tier switch arrangement is used. A first tier of switches is on the control plate 26, and a second tier of switches is, for example, above the control plate 26 on the switch support plate with a cut out 34 creating a nest and bordering thumb guides over the main navigation switches (steering & throttle).

On the face of the control plate 26, a raised central resting pad made of rubber and having a texture, such as ridges, can be disposed to provide, for example, the textured tactile location indicator 30. The four switch modules used for navigation control may be arranged in a diamond pattern and, for example, in the case of a piezo-electric switch, glued or otherwise fixed to the underside of the control plate 26 for throttle and steering. The face of the control plate 26 may be painted to display the touch sensitive area of each switch and/or a switch button (shown), raised circle (not shown), or other tactile-location representation, may be provided demarcating each control switch 24.

In accordance with an exemplary embodiment, the normal resting position while underway involves one or more of the fingers of the user (preferably all four fingers) positioned around the grip member 12 with the thumb resting on the thumb pad tactile location indicator 30. In accordance with this exemplary embodiment, every switch needed while under way can be reached safely and comfortably without removing fingers or at least having them in immediate range of the grip member 12. As non-limiting examples, ancillary switches 32, such as the hi/lo switch can be provided on the side of the control head 14, and the kill switch may be provided on the back of the control head 14. In accordance with an exemplary embodiment, the trim/tilt switches are located on the second tier (the switch support plate 28) and are positioned on the second tier closest to the thumb of the user.

The second tier switch support plate 28 may act as a guide for the thumb to guide it into the nest and onto the resting pad (the tactile location indicator 30), where the thumb is surrounded by the base tier switches (the first set of control switches 24). This exemplary construction provides the location indicator 30 residing within a home base for the thumb. The thumb then stays comfortably on the thumb pad tactile location indicator 30 while under way. When the thumb is removed, the home base is easily found by the user without having to look down at the grip member 12 or control head 14 by feeling for the tactile location indicator 30 with the thumb.

The second set of control switches 24 located on the second tier switch support plate 28 are arranged such that the ones normally activated while under way are closest to the thumb, for example, the trim/tilt switches. The hand of the user is not required to leave the grip member 12 when activating trim. Likewise, the thumb can return to the home base and easily feel for the location indicator 30 after, for example, trim/tilt switch activation, guided by proprioception alone. The kill and hi/lo switches located on the control head 14 may be activated, for example, by the index or third finger, or by the fingers of the other hand of the user. Shifting the propulsion system into forward (F), neutral (N), and reverse (R) preferably is only be done while the throttle is at dead slow, In the exemplary embodiment of the inventive integrated grab bar and navigation controller 10, those switches are positioned relatively further from the thumb (when resting at the location indicator 30).

Lights, such as LED indicators 36, can be provided, for example, to tell the user what gear the propulsion system is in, and also whether the hi/lo speed toggle is engaged allowing for high speed turning and high speed throttle up/down. The hi/lo switch provides a switch activation sensitivity switch for controlling a rate of change of the navigation control of the watercraft associated with at least one of the control switches 24.

The hi/lo speed toggle may be provided on the side of the control head 14, so it can be activated with the index or third finger while the thumb hits the throttle or direction switch. As shown in the Figures, a kill switch may be provided on the back of the control head 14.

In accordance with a non-limiting example, one or more of the control switches 24 and the ancillary switches 32 may be a piezo electric switch. An example piezo electric switch includes a housing and switch as a complete unit, in this case, a touch plate and switch disk are housed together as a unit. This example piezo electric switch can be, for example, inserted into a hole disposed in the control plate 26, switch support plate 28, grip member 12 or control head 14. An alternative piezo electric switch comprises just the switch disk itself, typically a metal disc measuring about ½″ diameter and 3/16″ thick. The metal disc may be glued or otherwise fixed to the control plate 26, switch support plate 28, or other locations, and the touch area may include indicia to indicate to the user the location of the control switch 24 or ancillary switch. A piezo electric switch senses pressure via surface tension deflection, with the typical thickness of the material over the switch being 0.5 to 1 mm in thickness. This sensed pressure is used to provide user control over servomotors and other mechanical and electrical elements in a “fly by wire” navigation control system. In accordance with an embodiment of the inventive integrated grab bar and navigational controller 10 piezo electric switches are utilized so that a water tight controller may be provided that has an unbroken surface (that is, no locations where water or dirt can penetrate) yet still enable one handed navigation control of a vehicle, such as a watercraft.

As an example of an important factor that distinguishes piezo switches as superior for outdoor marine application, the control head will accumulate salt deposits in the crevices between the switch plate activation buttons whenever the watercraft is used in a salty, marine environment. High pressure spray from a hose is the best way to clean out these deposits. It is normal routine for boats to be carefully washed down with a high pressure hose when returning from even a short voyage in salt water, in order to remove the salt which gets deposited everywhere. Piezo switches, such as those described herein, can be specifically designed to be unaffected by such cleaning.

The main navigation control switches 24 for throttle and steering (located on the first tier control plate 26) are all reachable with the thumb while under way. The gear change control switches 24 (F, N and R) are the furthest switches for the thumb to reach. Shifting gears, whether into forward, or reverse from neutral, or into neutral from forward or reverse, can only be done with the engine throttled back to idle RPM. The three gear shift switches are preferably positioned and the grip member 12 and control head 14 configured and dimensioned, so these control switches 24 are reached by sliding the hand of the user upward while holding the back of the control head 14 with the fingers of the same hand. Preferably, the grip member 12 and control head 14 (and control plate 26 and switch support plate 28) are configured and dimensioned so that at no time does the user's hand need to abandon its hold on the grip member 12 and control head 14 which act as an integrated grab bar with the control switches 24 acting as a navigation controller 10.

The control switches 24 for forward, neutral and reverse gear shifting may be located furthest from the location indictor because these switches will typically be used only at idle. The control switches 24 used for navigation while under way are preferably located closest to location indicator 30. During navigation, for example, the throttle and steering control switches 24 are activatable by contact applied from the thumb, with the thumb returning between activation to the location indicator 30 so that by feel alone the user maintains control over the activation of the switch and readiness to make course and speed corrections.

The inventive integrated grab bar and navigation controller 10 is effective for many vehicles, especially for watercraft that are typically subjected to jostling due to wave, wind and water action while under way (during navigation). Unlike a conventional joysticks used for controlling a vehicle, such as a watercraft, the inventive integrated grab bar and navigation controller 10 can be made watertight and substantially impervious to humidity and damage caused by exposure to corrosive and wet environments. In contrast to a typical navigation joystick, which must pivot in order to perform its intended function, in accordance with the operation of the inventive integrated grab bar and navigation controller 10, the same hand used to control the navigation of the watercraft also provides an effective grip on the grab bar to steady the user against movement caused by an applied force, such as that resulting from a wave or motion of the watercraft

In accordance with an exemplary embodiment of the inventive integrated grab bar and navigation controller 10, the control switches 24 are arranged into two tiers with the primary or most often used control switches 24 disposed around the core of the thumb's strongest and most comfortable range of motion. For example, the “primary” control switches 24 may be the trim, throttle and steering switches. These primary control switches 24 are typically the only ones that routinely get activated while under way (during navigation). In accordance with an exemplary embodiment of the present invention, the control switches 24 on the two tiers are slightly offset from each other so that a control switch 24 on the first tier (on the control plate 26) is not quite lined up with a control switch 24 on the second tier (on the switch support plate 28). Further, the ancillary switches 32 on the sides and back of the control head 14 may be activatable using the index (or another) finger of the user's hand. This non-limiting exemplary arrangement of control switches 24 and ancillary switches 32 allows the more critical “primary” switches to be disposed within the thumbs “power orb” and as the various control switches 24 get farther away from the location indicator 30 (which acts as a thumb rest and home base), the thumb's power and motility diminishes. The textured thumb pad (location indicator 30) allows the user to have a base of readiness-to-activate through proprioception at all times, limiting the risk of accidentally activating a “primary” navigation control switch, and without the user having to take his “eyes off the road.”

The reverse (R), neutral (N) and forward (F) gearshift control switches 24 are the furthest away, and, in accordance with a preferred construction, the user's handhold must slide upwards (but never off) the grip to reach them. Preferably, the gears can only be shifted when the boat is either in neutral, or idling at dead slow, with the user's hand never needing to completely let go of a handhold (i.e., the grip member 12 and/or the control head 14) when shifting. Thus, in accordance with the present invention, the rigid and non-moving grip member 12 enables an effective grab bar to be provided that in integral with the navigation controller 10 (the control switches 24).

In accordance with the inventive integrated grab bar and navigation controller 10, the user can maintain a whole-hand grip at all times while under way, and still using the same hand that maintains the grip can control the navigation of the watercraft. As a non-limiting example, in accordance an exemplary embodiment of the present invention, the grab bar provided by the grip member 12 and control head 14 meets the ABYC—“American Board and Yacht Council”—standard H-41 for handholds and grab rails and provide resistance for 300 pounds of force applied in any direction.

In accordance with an exemplary embodiment, the control switches 24 on the first tier, the control plate 26, are operable as a kind of “thumbstick” where each switch is activated by moving a thumb contact against a spring, so the user will receive feedback when a switch is activated.

In accordance with the inventive integrated grab bar and navigation controller 10, at no time will the operator have to let go of (unwrap his fingers from) the hand grip (grip member 12 and/or control head 14) to activate the control switches 24. The control switches 24 on the second tier, for example, may be reached by modifying one's grip, sliding the hand upwards on the grip to curl the fingers around gripping the control head 14, which now permits the operator to comfortably reach the gear shift buttons with the thumb. Once the shifting is done, the hand then slides back down the grip member 12, and the thumb returns to the location indicator 30 before accelerating (getting under way). The fingers maintain their wrap on the grip member 12 and/or control head 14 during the entire maneuver.

In accordance with the inventive integrated grab bar and navigation controller 10, the grip member 12 and control head 14 are rigidly fixed in place so it can function as a “handhold” grab bar. In accordance with a non-limiting exemplary embodiment, a mount 16 made of tubular stainless steel is welded in place on a tubular force transfer member 18, and the grip member 12 and control head 14 are fixed to the mount. In accordance with another non-limiting exemplary embodiment, the mount 16 is movable on the force transfer member 18.

The inventive integrated grab bar and navigation controller 10 is preferably made from corrosion resistant materials that can withstand weather, pressure washing and salt spray. As an example, piezo switches, such as those utilized by US Navy divers to operate equipment in the open sea at 400 feet below the surface of the water can be employed for the navigation controller 10.

Piezo electric switches can be utilized for control switches 24 that enable water tight enclosure of the, for example, the control plate 26 fixed to the control head 14. The control switches 24 can be indicated by indicia painted, embossed, silk screened, cast, or otherwise indicated on an un-fenestrated surface of the control plate 26 fixed on the grip member 12. In accordance with this aspect of the invention, there is no opening in the faceplate for water infiltration. There is a pressure receptor below the control plate 26, on the interior of the control head 14, and inside a sealed container, that is activated by pressing, for example, a painted area indicating the location of the switch on the control plate 26. In accordance with an aspect of the present invention, the location of the control switches 24 may be indicated by raised borders around the control plate 26 and/or the switch support plate 28, to present to the finger tactile identification. One or more of the control switches 24, for example, the gearshift control switches 24 located on the switch control plate 26, may be back lit and may be visible in sunlight. The preferred positioning and orientation of the control switches 24 relative to the hand of the user gripping the grip member 12 and relative to each other enable operation of a watercraft, such as a single engine boat, while getting under way, docking, cruising, in a seaway, etc., without the user having to “take his eyes off the road”.

In accordance with a non-limiting exemplary embodiment, the location indicator 30 on which the thumb rests does not activate anything, but rather provides a consistent tactile indicator for the user to locate by feel alone where the relative locations of the control switches 24 are as they relate to the user's thumb. At the location indicator 30, the thumb is able to rest, without any strain, while the user's fingers are wrapped around the grip member 12 to hold onto and resist unwanted movement of the user's body caused by an applied force resulting from a wave or movement of the watercraft while under way. At the same time, the user remains ready to alter speed or course at all times, even in rough sea conditions, without accidental course or speed change caused by applying a force to the grip member 12 (which would likely often occur if the grip member 12 were part of a conventional pivoting joystick). Minor course corrections and speed adjustments are performed with great frequency and are easily achieved by the thumb activating the navigation control switches 24 starting the known position and location of the thumb located at the location indicator 30. As an analogy, keeping one's thumb on the location indicator 30 is like keeping one's hands on the wheel while driving, even though you are not turning, or like having your foot near the accelerator and brake, even though you are on cruise control.

The tactile location indicator 30 may be positioned on the control plate 26 so that when not activating a control switch, the thumb rests on the tactile location indicator 30 to facilitate quick locating of a particular control switch 24 by the thumb while the fingers remain engaged with the grip member 12.

The mount 16 can include adjustment means to enable the user to adjust the grip member 12 relative to the force transfer member 18, the adjustment being substantially one of a position of the grip member 12 on the force transfer member 18, an angle of the longitudinal axis of the grip member 12 relative to the force transfer member 18 and rotation of the grip member 12 around the longitudinal axis so that the grip of the user's hand, the extension of the user's arm and the angle of viewing of the control switches 24 can be adjusted to suit the needs of the user.

At least some of the control switches 24, for example one or more of the four navigation control switches 24 located on the first tier on the control plate 26 that surround the location indicator 30, may be constructed having small paddles sticking up, which may be spring loaded and give a satisfying resistance when moved. In accordance with a non-limiting example, such a switch is activated by pressing the paddle away from the location indicator 30.

The control switches 24 may include a second set of control switches 24 located on a switch support plate 28, the second set of control switches 24 including a forward switch, a neutral switch, a reverse switch. The switch support plate 28 may be disposed relatively perpendicular to the control plate 26. Alternatively, the switch support plate 28 may be disposed relatively parallel to the control plate 26. The ancillary switches 32 can include a switch activation sensitivity switch (hi/lo) for controlling a rate of change of the navigation control of the watercraft associated with at least one of the control switches 24. The ancillary switch can also include at least one of a kill switch for quickly shutting down an engine of the watercraft and a warm up switch for warming up the engine of the watercraft.

At least two of the control switches 24 are thumb activated switches located within a range of motion of a thumb on the hand of the user so that the thumb activated switches are activatable by the thumb while maintaining a grip on the stick member by the hand of the user. In accordance with a non-limiting exemplary embodiment, the control switches 24 are piezoelectric switches mounted on the control plate 26, and the control plate 26 is a seamless plate member.

In accordance with an embodiment of the inventive integrated grab bar and navigation controller 10, a starboard armrest acts as a force transfer member 18 to hold the grip member 12. The armrest is rigidly fixed to a structural member of the watercraft, such as through a seat fixed to the floor of the watercraft. Preferably, to meet or exceed third party specifications for a marine grab bar, the grip member 12 and control head 14 are able to withstand substantially 300 pounds of force in any direction without movement relative to the force transfer member 18.

In accordance with a non-limiting exemplary embodiment, a strap may also be provided, for example, attached to the seat between the driver and passenger. This strap provides a second handhold that can be grabbed by the other hand of the user that is not being used for navigation control.

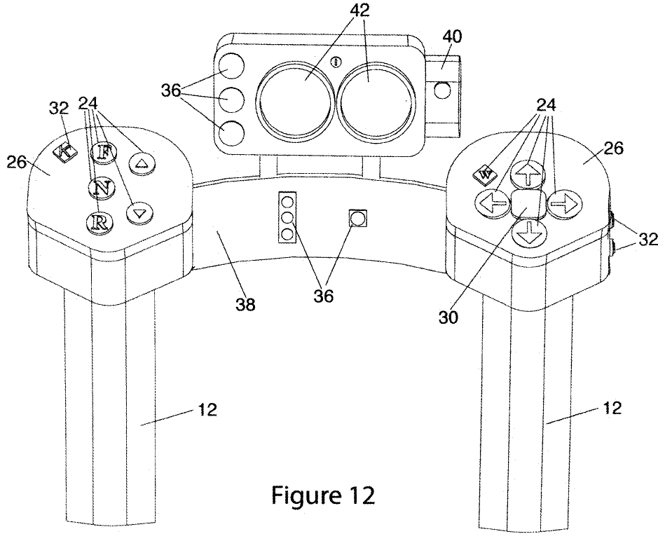

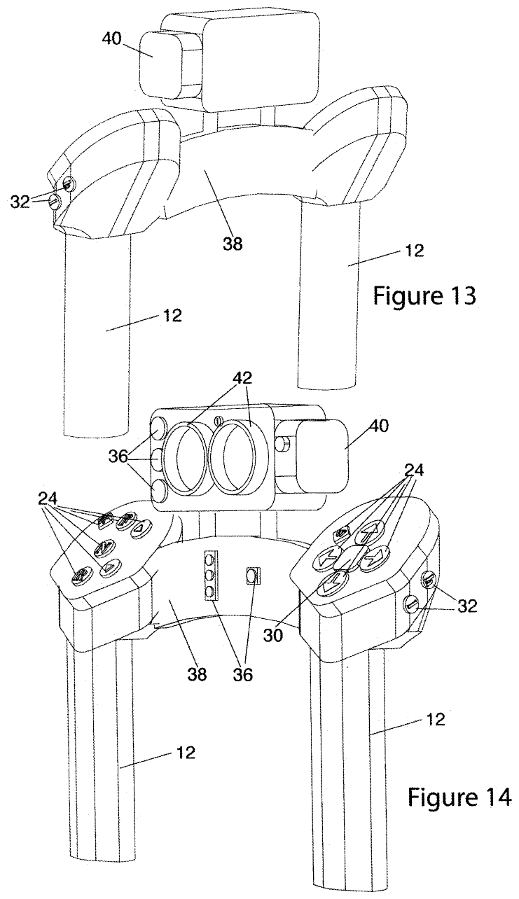

FIG. 12 is a front perspective view of an exemplary embodiment having a pair of grip members and control heads. FIG. 13 is a back perspective view showing the exemplary embodiment having a pair of grip members and control heads. FIG. 14 is a perspective view showing the exemplary embodiment having a pair of grip members and control heads. A two-handed grip can be provided for larger boats, with controls similar to a gaming controller used, for example, for X-Box and Playstation video games. In accordance with another aspect of the invention, a navigation controller 10 is provided for a vehicle, such as a watercraft. A force transfer member 18 transfers an applied force to a structural member of a watercraft. A mount is rigidly fixed to the force transfer member 18 for transferring the applied force to the force transfer member 18. A first grip member 12 and control head 14 are configured and dimensioned to be grabbed by a right hand of a user and a second grip member 12 and control head 14 are configured and dimensioned to be grabbed by a left hand of the user. The grip members are both rigidly mounted to the mount 16 for transferring the applied force to the mount 16. The right grip member 12 and control head 14 are engagable by fingers on the right hand of the user for providing a grab bar to the user to resist movement of the body of the user caused by the applied force. The left grip member 12 and control head 14 are engageable by fingers on the left hand of the user for providing a grab bar to the user to resist movement of the body of the user caused by the applied force.

The applied force is transferred through either or both the right hand and the left hand of the user to the respective grip member 12 to the mount 16 to the force transfer member 18 to the structural member to dissipate the applied force in resisting excessive movement of the body of the user caused by the applied force. Control switches 24 generate control output signals for controlling the navigation of the watercraft. A control plate 26 supports the control switches 24 and is disposed near to one of the right grip member 12 and the left grip member 12 and positioned, configured and dimensioned relative to the respective grip member 12 to enable a thumb or finger of the user to engage with one or more of the control switches 24 while the fingers remain engaged with the respective grip member 12. A tactile location indicator 30 is disposed on the control plate 26 to facilitate quick locating of a particular control switch 24 by the thumb while the fingers remain engaged with the grip member 12.

Indicators 36, such as colored LED lights, can be provided to indicate the status of the control switches 24 and the propulsion system of the vehicle. For example, activating the control switch 24 that shifts the propulsion system of the watercraft into neutral can be indicated by an appropriate LED light. A yoke 38 can be provided to rigidly fix the grip members 12 to each other, and to provide support for a radio 40 and status indicators 42, such as a tachometer, fuel gauge, and the like.

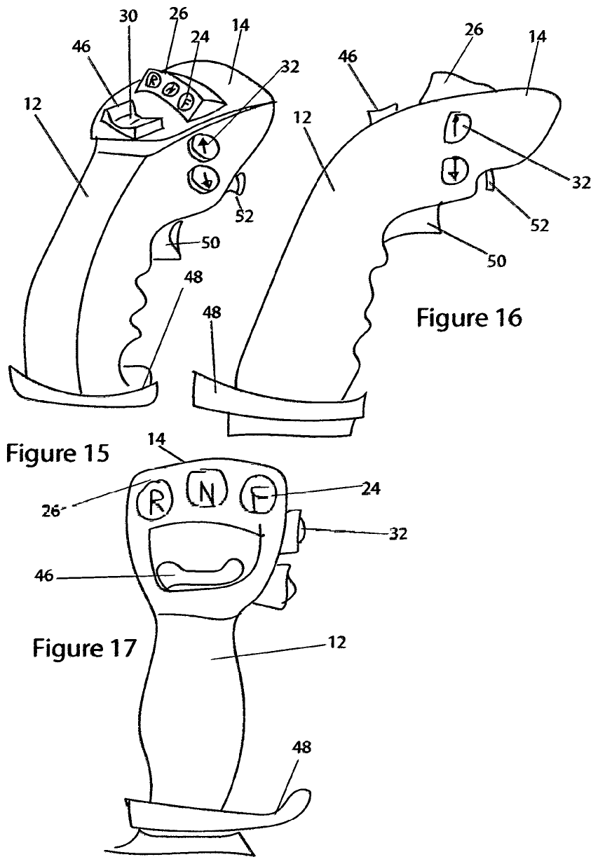

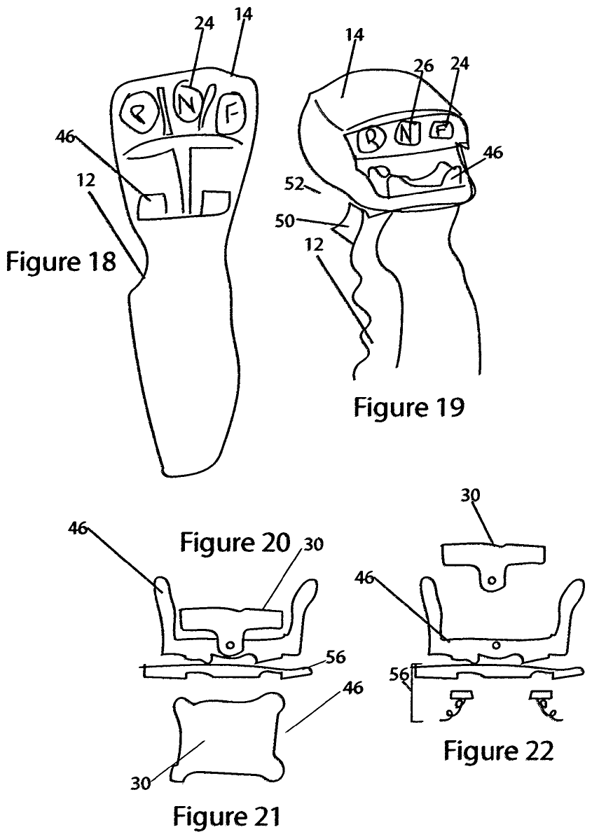

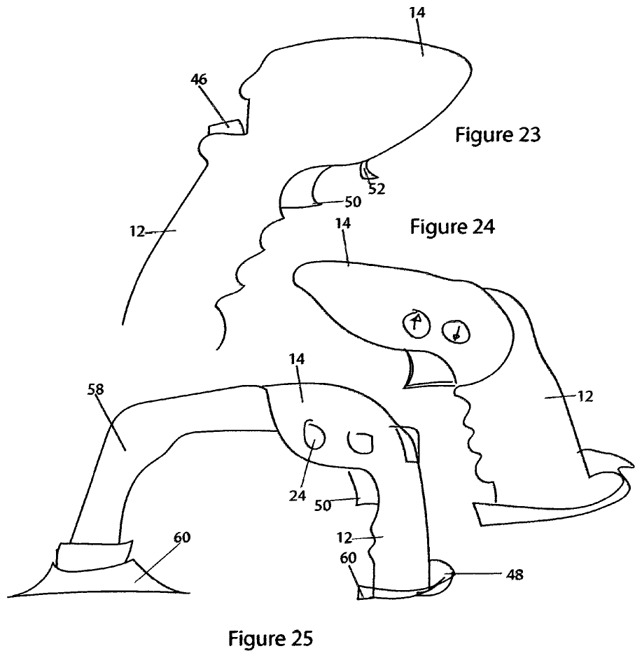

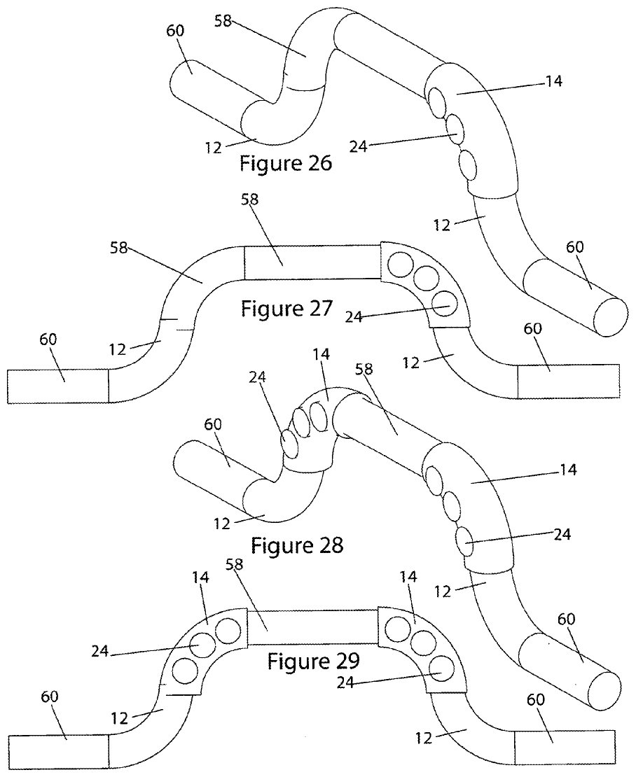

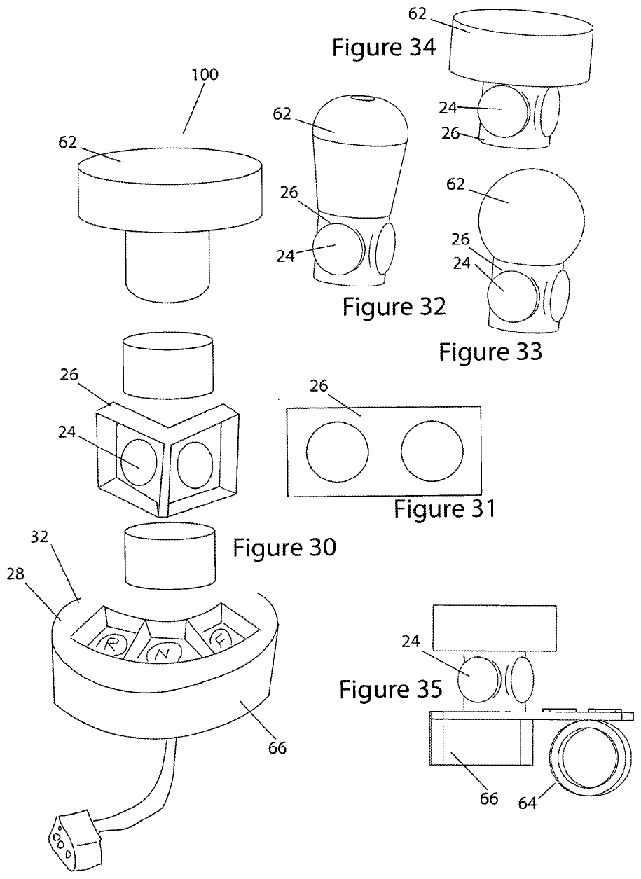

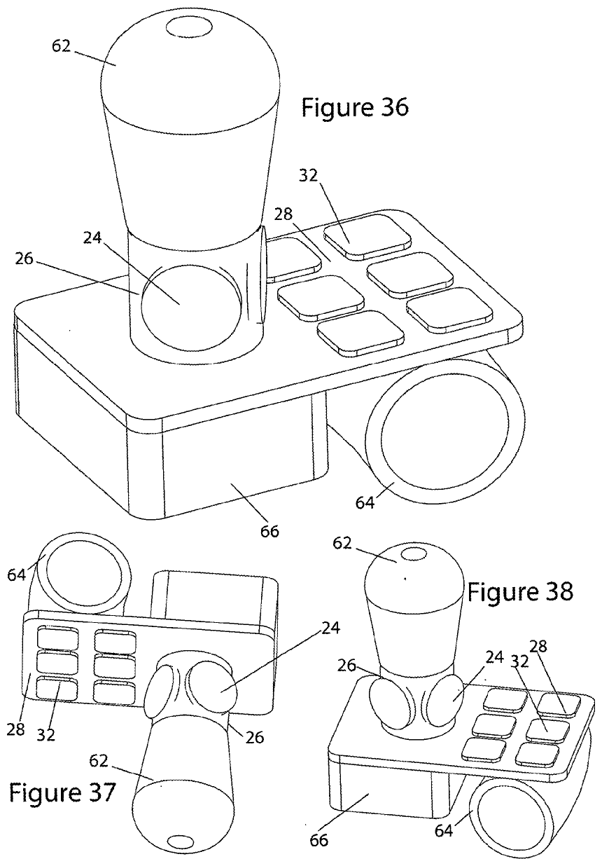

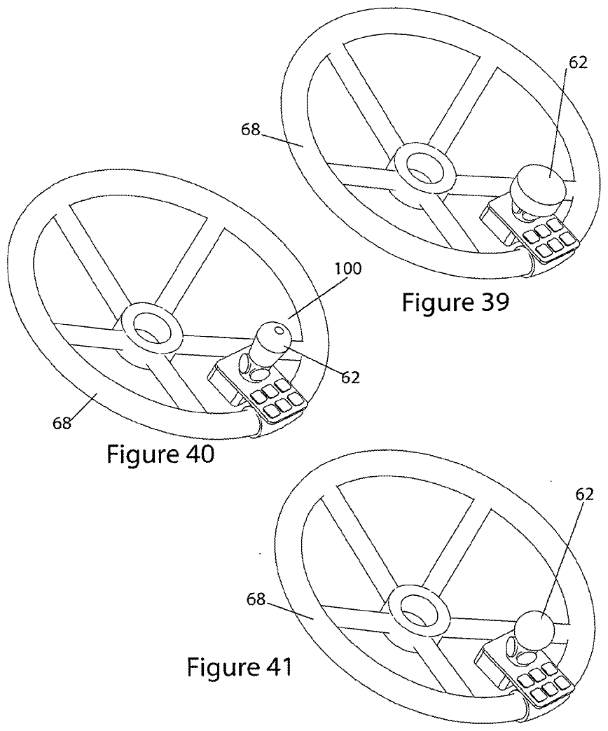

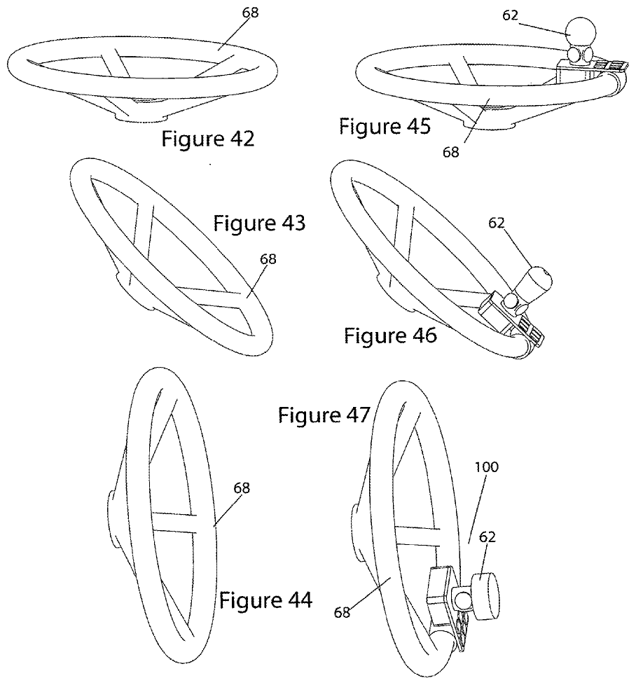

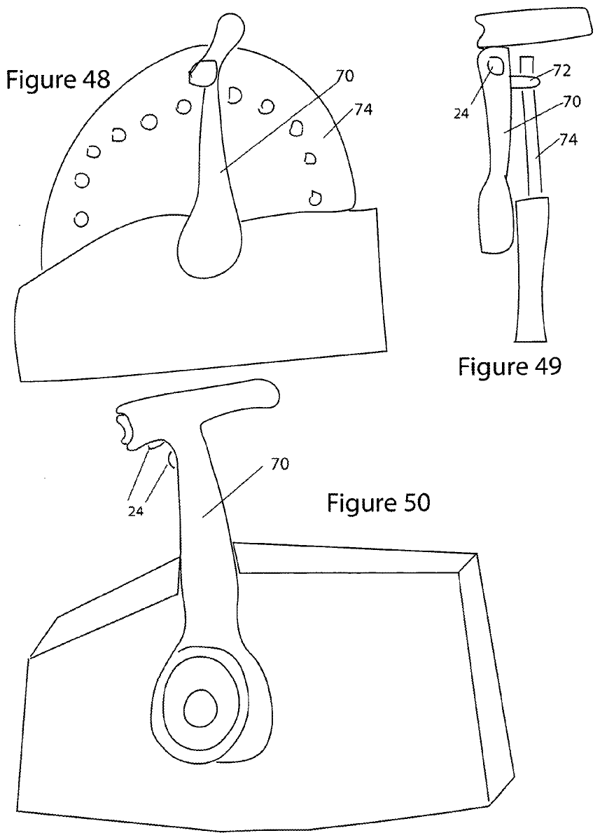

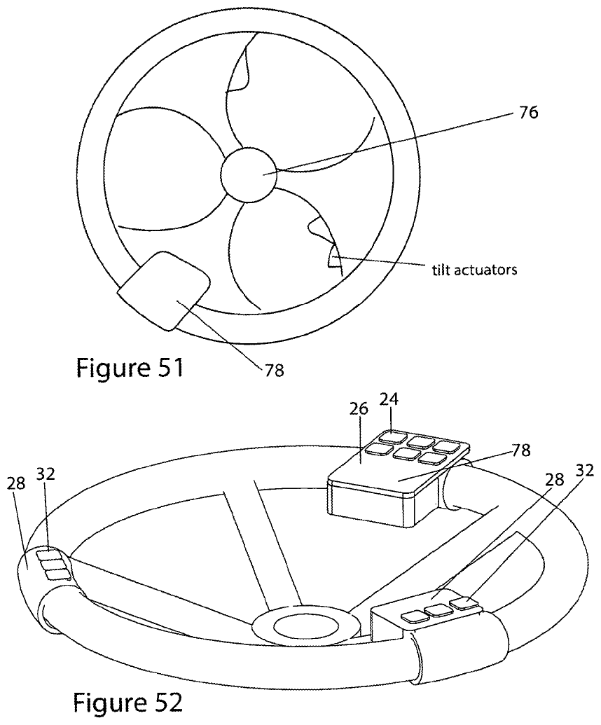

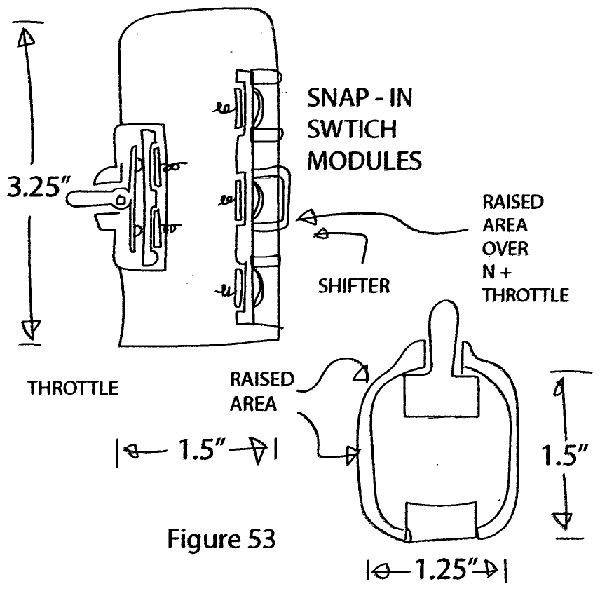

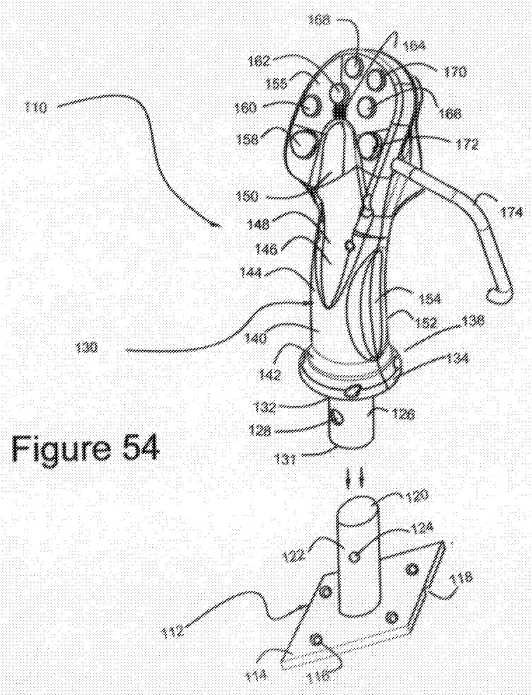

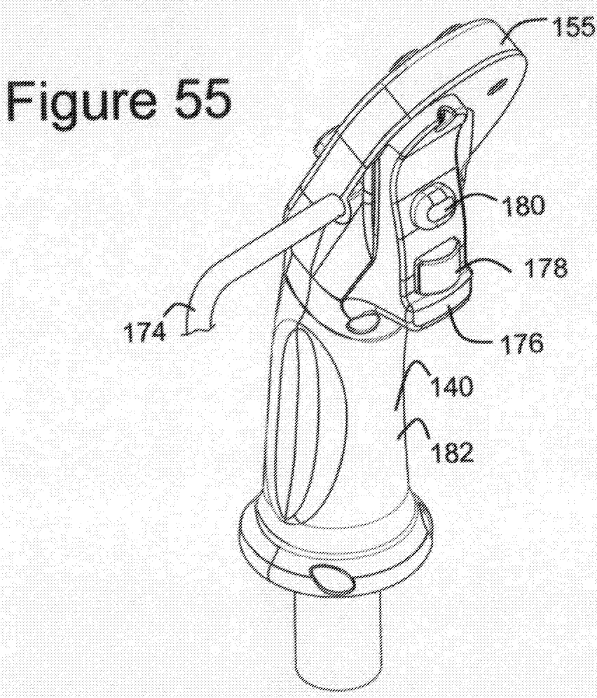

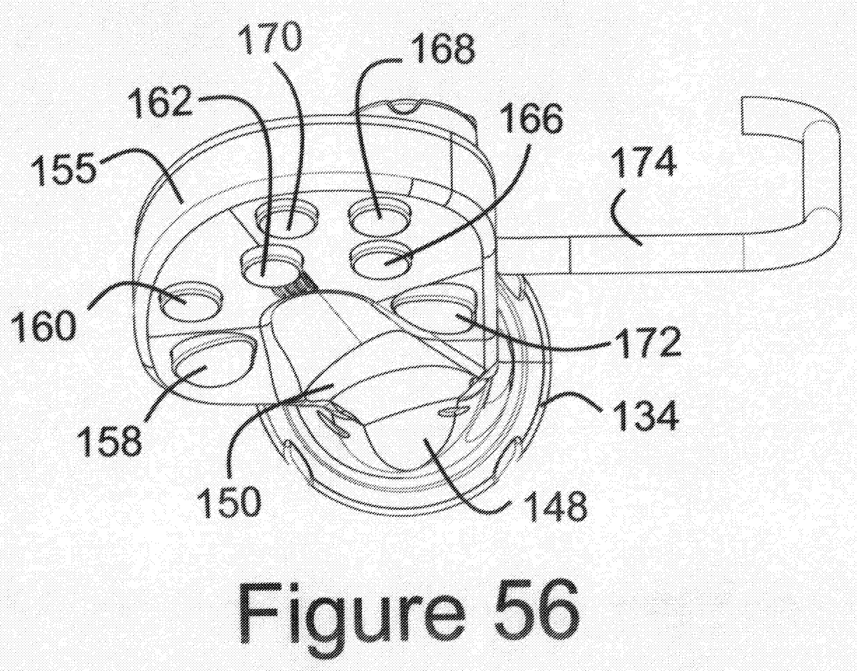

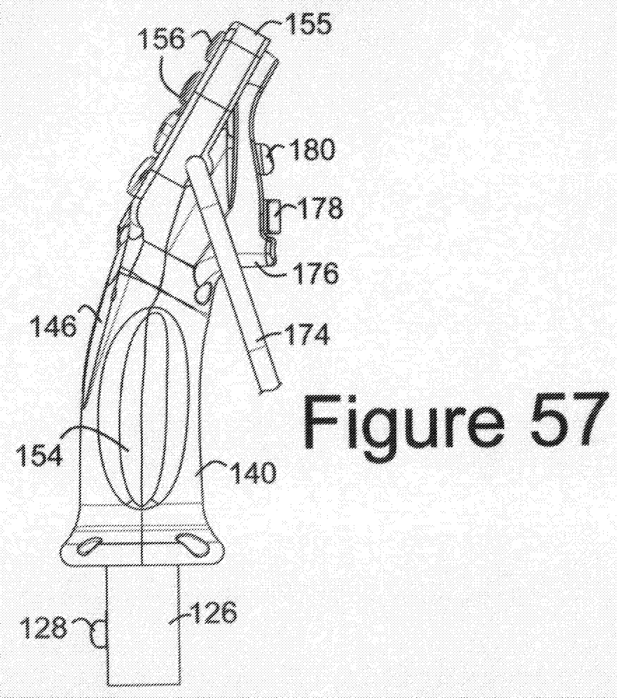

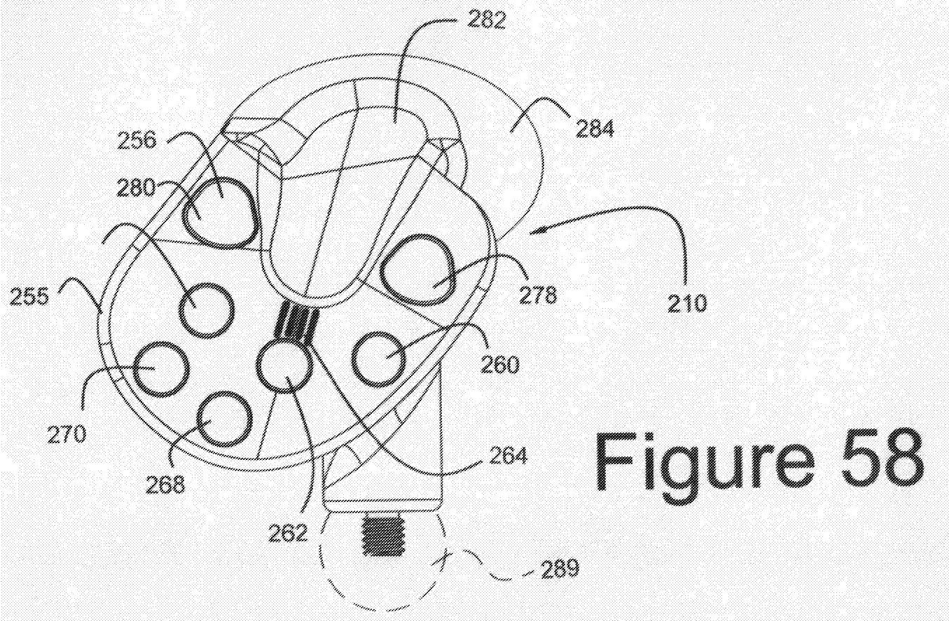

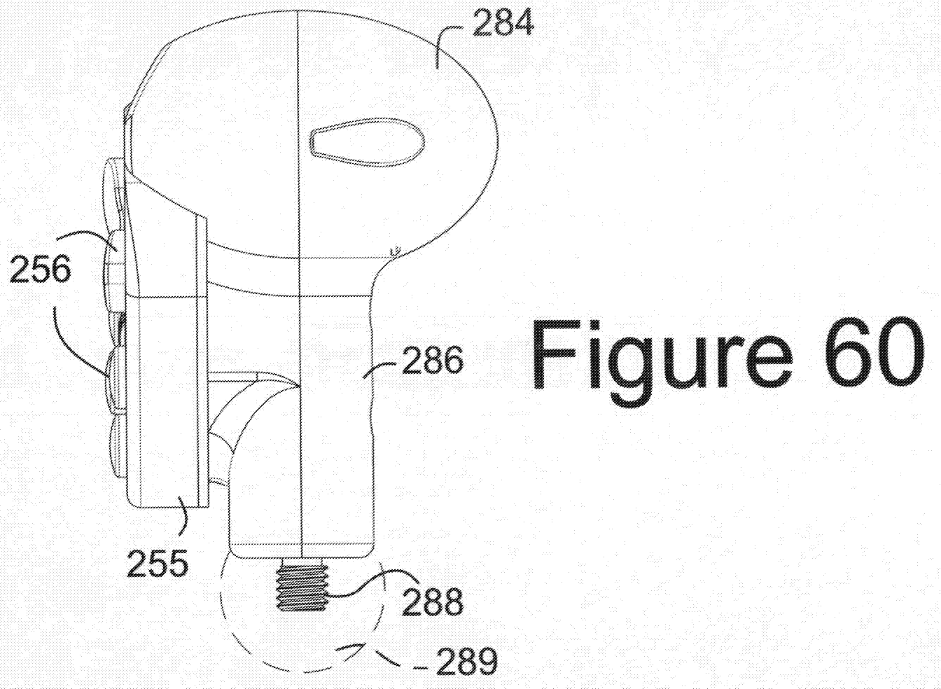

FIG. 15 is a perspective view of an exemplary embodiment showing a rocker switch 46 for controlling the direction of the vehicle, such as a watercraft, and trigger switch throttle up 50 and trigger switch throttle down 52 for controlling the speed of the vehicle, with a palm heel rest 48. FIG. 16 is side view of the embodiment show in FIG. 15. FIG. 17 is a front view of the embodiment shown in FIG. 15. FIG. 18 is a view of another embodiment. FIG. 19 is a partial perspective view of the embodiment shown in FIG. 18. FIG. 23 is a side view of another exemplary embodiment. FIG. 24 is an opposite side view of the embodiment shown in FIG. 23. As shown in the non-limiting, exemplary embodiments, the throttle may be controlled by a trigger switch and the directional switches, F, R, N, can be provided as button switches. An “anti-throttle”(throttle down) switch may be provided to throttle down and slow the watercraft.

As with the other exemplary embodiments shown herein, the inventive grab bar and navigation controller 10 provides a means for safely controlling a watercraft, even when underway in adverse sea conditions. For example, the rigidly fixed grip member 12 can be grabbed to steady the user because it is rigidly mounted to a mount 16 and resists movement in any direction. This mounting enables the transfer of an applied force while the rigidly fixed grip member 12 is gripped by fingers on the hand of the user. Thus, the rigidly fixed grip member 12 provides a reliable grab bar for the user to hold onto, even in severe weather, and resist movement. The movement may be caused by, for example, rocking of the watercraft when hit by a wave. In accordance with this exemplary embodiment, the primary control switches 24 and/or ancillary control switches 32 include at least one rocker control switch positioned on the control plate 26 for generating control output signals for controlling turning of the vehicle. For example, in accordance with an exemplary rocker switch 46, the user's thumb is positioned to roll left or right to actuate the rocker switch 46 and turn the watercraft, while the fingers remain positioned for grasping the fixed grip. Alternatively, or additionally, a rocker control switch may be used to provide throttle-up and throttle-down control of the vehicle. The primary control switches 24 and/or ancillary control switches 32 generate the control output signals that control the navigation of the vehicle. As with the other exemplary embodiments, the mount 16 supporting the rigidly fixed grip member 12 is itself rigidly fixed to a structural member of the vehicle and transfers an applied force, such as caused by the rocking of the watercraft, while the user grips the rigidly fixed grip member 12. The applied force is transferred to the structural member so the user remains steady. The control plate 26 supporting the primary control switches 24 and/or ancillary control switches 32 is disposed near to the rigidly fixed grip member 12 to enable a thumb or finger of the user to engage with one or more of the primary control switches 24, and/or ancillary control switches 32, while the fingers remain engaged with the rigidly fixed grip member 12. This enables the navigation of the vehicle controlled by activation of the primary control switches 24 and/or ancillary control switches 32, by the thumb of hand of the user while the rigidly mounted fixed grip member 12 remains engaged by the fingers of the hand. Thus, the rigidly fixed grip member 12 is structured, configured and dimensioned, to be gripped and provide a rigid grab bar that resists the unwanted and potentially dangerous movement of the user even when the watercraft is at speed and/or in high seas conditions.

A heel rest 48 may also be provided to help orient the hand of the user relative to the location of the grip member 12, the primary control switches 24, the ancillary control switches 32 and other components. This heel rest 48 facilitates the easy access to the navigation control and grab bar aspects of the inventive integrated grab bar and navigation controller 10.

FIG. 20 is a side view schematically showing an inventive rocker switch 46 with a tactile indicating resting pad. FIG. 21 is a top view schematically illustrating the rocker switch 46 shown in FIG. 20. FIG. 22 is an exploded view schematically illustrating the rocker switch 46 shown in FIG. 20. The primary control switches 24 and/or ancillary control switches 32 may include at least one rocker control switch positioned on the control plate 26 for generating control output signals for controlling the turning of the vehicle. For example, in accordance with an exemplary rocker switch 46, the user's thumb is positioned to roll left or right to actuate the rocker switch 46 and turn the watercraft, while the fingers remain positioned for grasping the fixed grip. A tactile indicating resting pad provides a tactile location indicator 30 positioned so that the thumb of the user can rest on the tactile location indicator 30 when controlling the direction of travel by rolling the thumb, or otherwise applying pressure to one side or the other of the location indicator 30. Electrical contact is made by actuating the switch components 56 of the rocker switch 46. The user's thumb can easily locate the resting pad tactile location indicator, even without the user having to look down to find it, and all the while the user's fingers remain engaged with the rigidly fixed grip member 12. Alternatively, or additionally, a rocker control switch may be used to provide throttle-up and throttle-down control of the vehicle.

The inventive rocker switch 46 includes an actuator 54 that pivots in response to, for example, the thumb of the user rolling right or rolling left to control the direction of the watercraft. Switch components 56 cooperate with the actuator 54 so that the intended control indicated by the user's thumb movement is applied as appropriate control signals to cause the desired steering of the watercraft. The switch components include since there are no moving parts, and the switch is not exposed, there is no issue at depth, with spray or with salt.

FIG. 25 illustrates an exemplary embodiment showing the rigidly fixed grip member 12 formed from a bent tubular member, such as rigid stainless steel or aluminum marine grade tubing. As with the other embodiments described here, preferably, the rigidly fixed grip member 12 and related components are able to withstand at least 300 pounds of force in any direction without movement relative to the force transfer member. This construction creates an effective grab bar for use even when the watercraft is at speed and/or experiencing rough weather and/or high seas. FIG. 26 is a perspective view showing the control head 14 positioned at one side of an upside down U shaped bent tubular member. FIG. 27 is a front view of the embodiment shown in FIG. 26. FIG. 28 is a perspective view showing dual control head 14s positioned at either sides of an upside down U shaped bent tubular member. FIG. 29 is a front view of the embodiment shown in FIG. 28. In accordance with other exemplary embodiments of the inventive grab bar and navigation controller 10, the rigidly fixed grip member 12 comprises a bent tubular member 58 having a fixing portion 44 for rigidly mounting the tubular member 58 to the mount. The control head 14 and/or control plate 26 are disposed along the tubular member 58 and positioned, configured and dimensioned relative to the rigidly fixed grip member 12 to enable a thumb or finger of the user to engage with one or more of the primary control switches 24 and/or ancillary control switches 32 while the fingers remain engaged with the rigidly fixed grip member 12. The bent tubular member 58 can be configured, for example, as an upside down U, with the fixing portion 44 comprising at least one leg extending from the bottom of the upside down U so that the fixing portion 44 can be secured so the applied force is transferred through the hand of the user to the rigidly fixed grip member 12 to a mount 16 to a force transfer member 18 to a structural member to dissipate the applied force in resisting excessive movement of the body of the user caused by the applied force.

FIG. 30 is an exploded view illustrating an exemplary embodiment of an inventive speed knob navigation controller 100. The navigation controller 100 includes a grip member 62 configured and dimensioned to be grabbed by a hand of a user. A mount is provided for mounting the grip member 62 to a steering wheel 68 of the vehicle. For example, the mount may include a switch support plate 28 that supports a shaft that has the grip fixed to a distal end of the shaft. The shaft may be mounted to the switch support plate 28 to allow primary switches 24, for allowing switch-activated navigation control such as throttle, steering and possibly the gear shifting, to rotate with the grip member 62 and maintain the same orientation to the hand at all time.

FIG. 31 is an isolated view of a control plate 26 on which are mounted control switches 24. In this case, the control plate 26 may be bent at an angle to form a tactile location indicator on which the control switches 24 are mounted.

The shape and size of the grip member 62 may vary depending, for example, on the user's preference. FIG. 32 shows a smooth transition knob with the control plate 26 shaft supporting piezo electric speed control switches 24. FIG. 33 shows a flat top knob with a control plate 26 shaft supporting piezo electric speed control switches 24. FIG. 34 shows a ball knob with a control plate 26 shaft supporting piezo electric speed control switches 24. As illustrated, regardless of the particular shape and size of the grip, the control switches 24 that control for example, throttle up and throttle down are always easy and convenient to locate and actuate while the user grips the grip member 62.

FIG. 35 illustrates a rotationally fixed grip member 62 mounted on a clamping mount 64. In accordance with this exemplary embodiment, the shaft also functions as the control plate 26 on which is mounted switches for activating engine control functions, such as throttle up and throttle down. The grip member 62 is mounted to be engagable by the hand of the user for rotating the steering wheel 68 by the user to steer the vehicle. The control switches 24 generate control output signals for controlling at least the speed of the vehicle. By this exemplary configuration, the critical control functions of steering and speed can be easily achieved by one-handed operation where the user controls the direction of movement of the vehicle, such as a watercraft, using the grip similar to the operation of a conventional speed knob but with the further ability for the same hand that grips the speed knob and turns the steering wheel 68 to simultaneously also control the engine speed (and hence the watercraft speed). To achieve this, the control plate 26 supports the control switches 24 and is disposed near to the grip member 62 and positioned, configured and dimensioned relative to the grip member 62 to enable a thumb or finger of the user to engage with one or more of the control switches 24 while the hand remains engaged with the grip member 62. Thus, in accordance with this exemplary embodiment, the user's hand remains engaged with the grip member 62 so that the steering of the vehicle is controlled by rotating the steering wheel 68 through movement of the grip member 62 by the user, while simultaneous activation of the control switches 24 by the thumb of hand or finger of the user also remains conveniently and safely available for one-handed speed and direction control.

FIG. 36 illustrates the smooth transition knob grip member 62 rotationally mounted on a clamping mount 64. FIG. 37 is an alternative view of the smooth transition knob grip member 62 rotationally mounted on a clamping mount 64 shown in FIG. 36. FIG. 38 is another alternative view of the smooth transition knob grip member 62 rotationally mounted on a clamping mount 64 shown in FIG. 36. In accordance with an aspect of the invention, a navigation controller 100 for a vehicle comprises a freely rotating, grip based, vehicle navigation controls mounted to a steering wheel 68. In accordance with this aspect of the invention, different from the fixed integrated grab bar and navigation controller 100, the steering wheel 68 of the vehicle is used as conventionally done to control the direction of the vehicle.

This grip and wheel combination, similar to the fixed grip that has thumb stick steering described herein, may include a full complement of all requisite actuators for total boat navigation. Similar to the inventive fixed grip navigation controller 100, in accordance with this aspect of the invention, single-handed navigation is enabled for essential boat controls, including, for example, steering, shifter and throttle. Actuators that are non-essential to navigation may be mounted elsewhere on the steering wheel 68, without additional equipment disposed at another location needed to be used for boat navigation and engine controls.

In accordance with this aspect of the invention, the inventive navigation controller 100 is rotationally mounted on the steering wheel 68 and rotates free of the turning of the wheel, with throttle and shifter actuators built into the navigation controller 100. The navigation controller 100 is mounted on the periphery of a steering wheel 68 and occupies the same space, for example, as a conventional speed knob would, and performs all of the functions of a speed knob. However, in accordance with the inventive navigation controller 100, navigation and engine control, for example, shifting and speed, are controlled through the rotationally mounted grip as well.

The control switches 24 may include a first set of control switches 24 located on the control plate 26, the first set of control switches 24 comprising at least a throttle up switch and a throttle down switch. As shown, for example, in FIGS. 36-38, the control plate 26 that supports the throttle up switch and throttle down switch can be formed from a cylinder that supports the rotationally mounted grip member 62. The control plate 26 supports the throttle up and throttle down control switches 24 and is disposed near to the grip member 62. The control plate 26 is positioned, configured and dimensioned relative to the grip member 62 to enable the thumb or finger of the user to engage with throttle switches while the hand grips the grip member 62. This enables one-handed operation of the speed and steering of the watercraft. The positioning and location of the throttle switches relative to the grip member 62 allows the user to always be in control of the steering of the watercraft while simultaneously controlling the speed of the watercraft by easily accessible thumb or finger activation of the throttle switches. During the one-handed operation of the watercraft, the hand of the user remains engaged with the grip member 62 so that the steering of the vehicle is controlled by rotating the steering wheel 68 through movement of the grip member 62 by the user while simultaneous activation of the control switches 24 by the thumb or finger of the hand of the user remains available.

The control switches 24 may further include a second set of control switches 24 located on the control plate 26 or located on a switch support plate 28. As shown, for example, in FIGS. 30 and 36, the switch support plate 28 may be, for example, a rigid plate that supports the control plate 26 configured as a shaft that supports the grip member 62. The switch support plate 28 is effective for supporting the second set of control switches 24 including at least one of a forward switch, a neutral switch, a reverse switch, a kill switch and a warm up switch.

The second set of control switches 24 located on the switch support plate 28 may be arranged such that the switches that are normally activated while under way are closest to the thumb, for example, the trim/tilt switches. In this case, the hand of the user is not required to leave the grip member 62 when activating trim. Likewise, the thumb can easily locate the throttle control switches 24 when the hand is gripping the rotationally mounted grip member 62. As described elsewhere herein, a location indicator may be provided to facilitate feeling for the location after, for example, trim/tilt switch activation, guided by proprioception alone. Kill and hi/lo switches may also be located on the switch support plate 28, or may be located elsewhere. Shifting the propulsion system into forward (F), neutral (N), and reverse (R) can only be done while the throttle is at dead slow, and the electronics that are controlled by the controller switches already include software or hardware mechanisms to prevent the shifting into forward or reverse except when the engine is at dead slow RPM. For this reason, the gear shift switches in secondary, or ancillary, controls at low by acceptable risk, as opposed to being included as primary at no risk.

Lights, such as LED indicators, can be provided, for example, to tell the user what gear the propulsion system is in, and also whether the hi/lo speed toggle is engaged allowing for high speed turning and high speed throttle up/down. The hi/lo switch provides a switch activation sensitivity switch for controlling a rate of change of the navigation control of the watercraft associated with at least one of the control switches 24.

The main navigation control switches 24 for throttle are all reachable with the thumb or finger while under way, allowing the same hand that rotates the steering wheel 68 to control direction to also activate the throttle up and throttle down switches to control the speed. This arrangement allows for easy one-handed operation of, for example, a watercraft. The gear shift switches for Forward, Neutral and Reverse may be positioned relative to the rotationally mounted grip member 62 so these gear control switches 24 can be easily reached by sliding the hand of the user down from the grip while still maintaining the ability to rotate the steering wheel 68 and control directional navigation.

The control switches 24 for forward, neutral and reverse gear shifting may be located furthest from the location indictor because these switches will typically be used only at idle. The control switches 24 used for speed control (throttle up and throttle down) while under way are preferably located closest to location indicator. During navigation, for example, the throttle control switches 24 can be activated by contact applied from the thumb or finger with the thumb or finger locating the throttle control switches 24 by feel alone so that the user maintains control over the activation of the switch and readiness to make course and speed corrections.

FIG. 39 illustrates the flat top knob grip member 62 rotationally mounted through the clamping mount 64 to a steering wheel 68. FIG. 40 illustrates the smooth transition knob grip member 62 rotationally mounted through the clamping mount 64 to a steering wheel 68. FIG. 41 illustrates the ball knob grip member 62 rotationally mounted through the clamping mount 64 to a steering wheel 68. The mount may comprise a clamp for removably clamping the grip member 62, control switches 24 and control plate 26 to the steering wheel 68. The grip member 62 may be rotationally mounted on the mount. The grip member 62 may be pivotally mounted on the mount 16 to accommodate an angle of the steering wheel 68 relative to a position of the user. A tactile location indicator (shown elsewhere herein) may be positioned on the control plate 26 so that when not activating a control switch, the thumb of the user can locate and rest on the tactile location indicator to facilitate quick locating of a particular control switch by the thumb while the fingers remain engaged with the grip member 62 and vice versa (thumb remains engaged while fingers locate and rest on tactile location indicator).

FIG. 42 illustrates a steering wheel 68 having a horizontal attitude. FIG. 43 illustrates a steering wheel 68 having an angled attitude. FIG. 44 illustrates a steering wheel 68 having a vertical attitude. FIG. 45 illustrates a steering wheel 68 having a horizontal attitude the ball knob grip member 62 rotationally mounted through the clamping mount 64 to a steering wheel 68. FIG. 46 illustrates a steering wheel 68 having an angled attitude the smooth transition knob grip member 62 rotationally mounted through the clamping mount 64 to a steering wheel 68. FIG. 47 illustrates a steering wheel 68 having a vertical attitude the flat top knob grip member 62 rotationally mounted through the clamping mount 64 to a steering wheel 68.

The grip of the inventive navigation controller freely rotates independently of the wheel, similar to the conventional speed knob. Accordingly, as described herein accommodation must be made if the control switches 24 or other electronics contained in an electronics housing 66 rotating with the navigation controller 100 and/or steering are hardwired to prevent wires from becoming twisted and broken. This embodiment uses actuators and electronic circuits similar to the other embodiments described herein and the operator of the vehicle can control the essential movements of his craft with one hand at all times. As an alternative to being hardwired, the switches and other electronics contained in the electronics housing 66 rotating with the navigation controller 100 and steering wheel 68 may utilize wireless communication between a transmitted/receiver associated with the navigation controller 100 mounted switches and electronics and actuators and other electronic components located elsewhere to provide, for example, fly-by-wire type electronic control of aspects, such as, engine throttle, gear shifting, etc.

FIGS. 42-44, illustrate the ergonomic considerations for the hand, different types of knobs may work better in the than at different wheel attitudes relative to the hand. A steering wheel 68 may be mounted having a variety of attitudes. In accordance with an exemplary embodiment, the inventive navigation controller 100 can be a retrofit to a pre-existing steering wheel 68. For example, a boat may come equipped with a conventional steering wheel 68, with the typical throttle controls usually located remote from the steering wheel 68 but accessible to the user while steering the boat. In this case, the user typically uses one hand to rotate the steering wheel 68 and the other hand to adjust the throttle up or down, shift gears, etc. In accordance with the inventive navigation controller 100, the user is able to use single-handed operation for simultaneously steering and adjusting, for example, the speed of the boat with one hand. Whether configured as OEM or as a retrofit to a pre-existing boat steering wheel 68, the inventive navigation controller 100 is fixed to the steering wheel 68 so that the rotationally mounted grip member 62 is comfortably engaged with the user's hand and used to rotate the steering wheel 68. Since the attitude of the steering wheel 68 may vary from boat to boat, in accordance with an exemplary embodiment the inventive navigation controller 100 can be mounted so that the angle of the grip member 62 relative to the attitude of the steering wheel 68 results is a comfortable and convenient grip.

The grip of the inventive navigation controlled freely rotates independently of the wheel, similar to the conventional speed knob. Accordingly, as described herein accommodation must be made if the control switches 24 or other electronics contained in the electronics housing 66 rotating with the navigation controller 100 and/or steering are hardwired to prevent wires from becoming twisted and broken. This embodiment uses actuators and electronic circuits similar to the other embodiments described herein and the operator of the vehicle can control the essential movements of his craft with one hand at all times. As an alternative to being hardwired, the switches and other electronics rotating with the navigation controller 100 and steering wheel 68 may utilize wireless communication between a transmitted/receiver associated with the navigation controller 100 mounted switches and electronics and actuators and other electronic components located elsewhere to provide, for example, fly-by-wire type electronic control of aspects, such as, engine throttle, gear shifting, etc.

When used for navigation on a boat, for example, steering wheels 68 are used both from a seated position when a console and seat are present, and also and from a standing position, utilizing a leaning post with a taller console.

As shown, for example in FIGS. 45-47, in accordance with exemplary embodiments, accommodation is provided for different mounting angles of the wheel, to assure comfortable and safe operation of the controls at all times.

For example, the mount may include position adjustment means for adjusting at least one of the angle, location and rotation of the grip member 62. For example, the clamping mount 64 may include one or more thumb screws (not shown) that then tightened squeeze the mount 16 angularly against the steering wheel 68 grip. By loosening the thumb screws or otherwise loosening the mount 16 from the steering wheel 68 grip, the grip member 62 can be made to pivot relative to the steering wheel 68 and accommodate a comfortable gripping position for the user. Alternatively or additionally, when more extreme attitudes suggest larger adjustments, the switch support plate 28 or other structure on which the grip member 62 is supported can have a hinged portion (not shown) that is able to pivot and then be locked in place when a comfortable gripping position is obtained. As another alternative, the grip member 62 may be supported on a structure that includes a ball joint (not shown) with a position locking mechanism can be provided that allows for a wide range of rotated or pivoted or otherwise changeable positions of the grip member 62 relative to the steering wheel 68, again, for more extreme wheel attitudinal challenges.

FIG. 49 illustrates an alternative aspect of the invention showing a throttle position locking mechanism where steering by wire controls are mounted on conventional outboard shift and throttle controls. FIG. 50 shows the throttle position locking mechanism, where steering by wire controls are mounted on conventional outboard shift and throttle controls.

As illustrated, a boat throttle arm having right and left steering switches 24 for enabling one-handed control of steering and throttle of a watercraft. 12. In accordance with an exemplary embodiment, a navigation controller for a watercraft includes control switches 24 for generating control output signals for controlling the navigation of the watercraft. The navigation of the watercraft controlled by the control switches 24 is the steering of the watercraft. In accordance with this exemplary embodiment, a steering wheel 68 conventionally used to steer the watercraft may or may not be provided. Steering is accomplished by actuating the control switches 24 using at least one of one or more fingers and a thumb of a hand of a user. The actuating of the control switches 24 causes an electrical signal to be transmitted that is used for actuating servomotors, hydraulics, and other mechanical mechanisms that cause elements of the watercraft, such as a rudder, engine, or other thruster to change its angle relative to the watercraft and cause an intended change in direction of the watercraft.

A control plate 26 support the control switches 24. The control plate 26 is mountable to a lever arm 70, The lever arm 70 is pivotally mounted for providing throttle control and gear shifting depending on a pivoted position of the lever arm 70. In accordance with the exemplary embodiment, the navigation of the watercraft is controlled by actuating the control switches 24 using at least one of one or more fingers and a thumb of the hand of a user. Thus, one-handed control of the navigation of the watercraft is achieved by actuating the control switches 24 for controlling the steering of the watercraft while using the same hand and arm of the user for changing the pivoted position of the lever arm to provide throttle control and gear shifting.

In accordance with another aspect of the invention, vehicle steering navigation is achieved by locating steering control switches 24 on a support structure such as a lever arm 70. For example, a conventional outboard motorboat includes a lever arm 70 that provides gear shifting and throttle control. To shift gears, the lever arm 70 is pushed forward from neutral into forward and then, as the lever arm 70 is continued to be pushed forward, it becomes the throttle. The farther forward the lever arm 70 is pushed, the faster the boat is propelled over the water. In accordance an exemplary embodiment, a detent pin 72 and grille 74 mechanism is provide to stabilize the lever arm 70, to prevent an unintended change in the pivot position of the lever arm 70.

A detent pin 72 and grille 74 mechanism may be provided for preventing an unintended change in the pivot position of the lever arm 70. The detent pin 72 is removably engageable with the grille 74 so that when engaged with the grille 74 the lever arm 70 is prevented from changing the pivoted position. A tactile location indicator positioned can be included on the control plate 26 so that when not activating the control switches 24, the thumb of the hand rests on the tactile location indicator to facilitate quick locating of the control switches 24 by the thumb. Also, a switch activation sensitivity switch may be provided for controlling a rate of change of the steering navigation control of the watercraft associated with the control switches 24.

FIG. 51 shows a steering wheel having warmup and tilt actuators, along with a speed knob grip bed, and a hub with a clock spring mechanism for providing a wired connection to the actuators while allowing the wheel to turn. FIG. 52 shows a steering wheel 68 having warmup and tilt actuators, along with a speed knob grip bed 78, and a hub 76 with a clock spring mechanism (not shown) for providing a wired connection to the actuators while allowing the wheel to turn. Clocksprings typically comprise a flat multicore cable wound in a spiral shape similar to a clock spring. For example, in vehicle steering systems a clockspring is a spiral-wound special rotary electrical connector allowing a steering wheel 68 to turn while still making an electrical connection between a switch component, for example, the steering wheel 68 airbag, home, radio volume adjustment, etc. and the vehicle's electrical systems. The clockspring is typically located between the steering wheel 68 and the steering column. Alternatively, the same purpose of rotational electrical contact may be achieved using spring-loaded brushes contacting concentric slip rings.

A grip bed 78 is provided for mounting the grip member 62, control switches 24, etc., and provides a stable platform to mount the lazy susan base of the grip. The grip member 62 can also be made as an extension of the steering wheel 68 rim. The wiring for the switches 24 passes through and goes underneath a spoke piece of the steering wheel 68 68 and runs down into the hub and thereby passes below to a waterproof control box. The actuating of the control switches 24 causes an electrical signal to be transmitted that is used for actuating servomotors, hydraulics, and other mechanical mechanisms that cause elements of the watercraft, such as a rudder, engine, or other thruster to change its angle relative to the watercraft and cause an intended change in direction of the watercraft.

A clockspring mechanism is required inside the hub, which prevents winding of the wiring as it goes through the hub. The wiring that goes from the base of the grip member 62 under the spoke piece and toward the hub also experiences winding because while the wheel turns, the grip remains unmoving in the hand. A simple coiled telephone cord type wiring harness may be provided to alleviate any tension and prevent winding for this segment of the wire run.

In accordance with an exemplary embodiment, a grip member 62 is configured and dimensioned to be grabbed 78 by a hand of a user. Control switches 24 generate control output signals for controlling at least the speed of the vehicle. A control plate 26 supports the control switches 24 and is disposed near to the grip member 62 and positioned, configured and dimensioned relative to the grip member 62 to enable a thumb or finger of the user to engage with one or more of the control switches 24 while the hand remains engaged with the grip member 62 so that the steering of the vehicle is controlled by rotating the steering wheel 68 through movement of the grip member 62 by the user while simultaneous activation of the control switches 24 by the thumb or finger of the hand of the user remains available, A mount bed 78 is attachable to a steering wheel 68 of the vehicle. The mount bed 78 is configured for retrofitably mounting the grip member 62 to the steering wheel 68 so that the grip member 62 is engagable by the hand of the user for rotating the steering wheel 68 by the user to steer the vehicle.

In accordance with an exemplary embodiments, the control switches 24 that control the throttle do not rotate with the grip member 62 and are on the control plate 26 so that they can be quickly located with a constant position relative to the hand of the user at all times. For safety, the primary control switches 24 maintain a constant orientation to the hand of the user at all times, and the primary control switches include switches for throttle and steer by may or may not include gear shifting.

The control switches 24 include a first set of control switches 24 located on the control plate 26, the first set of control switches 24 comprising at least a throttle up switch and a throttle down switch. Thus, in accordance with this aspect of the invention, the user can easily steer the vehicle while controlling the speed of the vehicle at the same time.

A second set of control switches 32 can be located on a switch support plate 28. The second set of control switches 32 including at least one of a forward switch, a neutral switch, a reverse switch, a kill switch, tilt switches and a warm up switch. The switch support plate 28 is mountable at a location on the steering wheel 68 different from a location of the mount bed 78.

Also, a third set of control switches 32 can be located on a second switch support plate 28. The third set of secondary control switches 32 might include at least one of a forward switch, a neutral switch, a reverse switch, a kill switch, tilt switches and a warm up switch. The second switch support plate 28 is mountable at a location on the steering wheel 68 different from the location of the switch support plate and the location of the mount bed 78.

FIG. 53 illustrates a rotationally mounted grip member that is configured for being received on a shaft fixed to, for example, the mount bed. The grip member may be, for example, about 3.25″ tall, with switch modules that snap into the grip member. Three gear switches, reverse, forward and neutral, may be recessed inside the grip area of the grip member and received within an invagination formed in the grip member. A raised grid, which may be further protected by a larger raised safety ring can be provided around the middle of grip member all the way to a control switch that functions as a throttle actuator. This raised area around the middle of the stick allows the operator to locate the switches by proprioception, such that taking his eyes off the surroundings is not necessary. The raised grid and raised ring provide a tactile location indicator that allows the user to feel the location of the switches without having to look down while navigating.

Referring to FIG. 54, inventive navigation controller 110 comprises a stainless-steel support base 112 that rigidly attaches navigation controller 110 to a surface of the boat, such as the dashboard.

Stainless-steel support base 112 comprises a rectangular planar support plate 114. Support plate 114 defines four cone-shaped holes 116 positioned proximate each corner of rectangular support plate 114. The rectangular planar bottom 114 has an arc-shaped indentation 118 that extends the long edges of the support plate 114 along the radius of inner surface 120 of mounting pipe 122. The indentation 118 is positioned closer to holes 116 that face the user of the navigation controller 110 and passes along the radius of the connection hole 120.

Mounting Pipe 122 extends at an angle from the planar support plate 114. Mounting Pipe 122 is made of stainless-steel. Mounting Pipe 122 is positioned closer to holes 116 forming an obtuse angle with the support plate 114 facing the user and an acute angle with the support plate 114 facing away from the user of the navigation controller 110. Stainless-steel mounting pipe 122 has a cone-shaped receiving port 124 located in the middle of the obtuse side of the mounting pipe 122 directly facing the user of the navigation controller 110.

In addition to stainless steel support base 112, navigation controller 110 further comprises a removable navigation controller 130. Removable navigation controller 130 mounts on mounting pipe 122. Mounting pipe 122 is dimensioned to allow it to snugly slide into stainless-steel pipe 126 on removable navigation controller 130. This allows the user to alternate between placing removable navigation controller 130 on mounting pipe 122 or, if desired, to hold removable navigation controller 130 during operation of the boat.

Removable navigation controller 130 comprises a main body which, for example, may be made of injection-molded plastic, into which cylindrically-shaped stainless-steel pipe 126 is secured. Once stainless-steel pipe 126 is mounted on mounting pipe 122, stainless steel pipe 126 may be attached to stainless-steel bracket 122 using a conventional spherically-tipped steel detent pin 128. Steel detent pin 128 is slightly closer to stainless-steel pipe edge 131 than stainless-steel pipe end 132 and faces the user of navigation controller 110. To remove controller 130, the user applies pressure to steel detent pin 128 until steel detent pin 128 slides into receiving port 124 at a position radially inward of mounting pipe 122, allowing removal in a conventional fashion. Alternatively, to lock control the 130 in position, pin 128 extends through port 124 and this secures removable navigation controller 130 in on the inside 120 of pipe 122.

When removable navigation controller 130 is mounted on mounting pipe 122, stainless-steel pipe end 132 rests directly on top of connection hole 120. is Support base 134 of removable navigation controller 130 is positioned above and secured to stainless-steel pipe end 132. Support base 134 has a circular base 138 that forms the base of grip 140. The width of support base 134 is slightly greater than the width of grip 140 and connects with an inwardly-curved angle out to lip 142 of removable navigation controller 130.

Grip 140 is generally cylindrically-shaped and reasonably accommodates the size of a hand wrapped around the same. User-facing side 144 has a grip imprint 146 that is a slight depression in grip 140 that extends from the upper edge of grip 140 to below the middle of grip 140. Grip imprint 146 has a rectangular-shaped portion 148 that connects to a roughly thumb-shaped portion 150. Grip imprint 146 accommodates the user's thumb and the edge of the user's palm below the thumb. Grip 140 has a straight edge 152 to the right of the user's thumb with a slight dent 154 for the user's distal transverse palm crease to rest on. Straight edge 152 extends to ovular-shaped control panel 155.

Control panel 155 contains seven push-buttons 158-162 and 166-172 made, for example, of a hard plastic. To the left of the thumb is left turn button 158 which when pressed is connected to onboard systems for steering the boat to the left. Resting above left turn button 158 is reverse button 160 which is connected to actuate controls for putting the motor in reverse. To the right of reverse button 160 is neutral button 162 which is connected to put the motor into neutral. Below neutral button 162 are four raised lines 164 reaching to the top of grip imprint 146. These four raised lines 164 indicate the location of neutral button 162 and act to make less likely accidental upward movement by the user's thumb. To the right of neutral button 162 is forward button 166, which is connected to put the motor into forward gear when it is actuated. Directly above neutral button 162 is tilt down button 168 for the outboard motor trim of the boat, which is connected to lift the end of the engine out of the water. Above forward button 166 is tilt up button 170 for the outboard motor trim, which when activated lifts the prop end of the outboard out of the water. To the right of grip imprint 146 is right turn button 172, which is connected to steer the boat to the right.

Of course, if the boat is equipped with an inboard engine, tilt controls would not be included in the inventive controller.

Left turn button 158, reverse button 160, neutral button 162, forward button 166, tilt down button 168, tilt up button 170, and right turn button 172 make up the switch board controls in control panel 155 that control the operation of the boat.

Extending to the right of right turn button 172 along straight edge 152 is cable 174. Cable 174 extends to a commercially available control box that contains a hydraulic pump mechanism connected to the outboard engine or rudder, the mechanical throttle arm, and the mechanical shifter.

As an alternative to cable 174 wireless, such as Bluetooth-based, controls may be employed.

Control panel 155 forms a slight angle with the rear of grip 140. See FIGS. 55-57. The back of control panel 155 comprises a finger rest 176, a throttle down button 178, and a throttle up button 180. Finger rest 176 forms a right angle with user-adjacent side 182 of grip 140. Closest to grip 140 is finger rest 176. The user can rest his or her finger on finger rest 140 until the user needs to apply pressure to throttle down button 178 or throttle up button 180. Throttle down button 178 and throttle up button 180 control the throttle, and thus effectively the speed, of the boat.

During use of navigation controller 110, the user wraps his right hand around grip 140 of controller 130 with his or her thumb positioned on thumb rest 150. The thumb is used to actuate either the throttle down button 158 or the throttle up button 172. Alternatively, if I may be used to actuate button 160, button 162 or button 166 to control the operation of the boat. To adjust trim, the thumb may be extended to actuate pushbuttons 168 or 170. Because the trim is relatively infrequently used, buttons 168 and 170 are positioned at relatively large distances from the natural resting position of the user's thumb on thumb rest 150.

Referring to FIGS. 58-60, an alternative embodiment of the invention suitable for mounting on the steering wheel of a boat comprises an inventive “spinner” configured controller 210 which may be made of injection-molded plastic and comprise a control panel 255, grip 240, and wheel attachment 282.

In accordance with this embodiment, it is contemplated that controller 210 is mounted for rotation on the steering wheel with the palm of the hand in engagement with the outer surface 211 of the controller 210 to allow steering of the steering wheel. At the same time, the thumb is free to operate the various pushbuttons on controller 210, when not resting on thumb rest 282.

Control panel 255 comprises throttle up button 280, a forward button 266, throttle down button 278, a neutral button 262, a reverse button 260, a tilt down button 268 and a tilt up button 270, which together make up the switch board controls on control panel 255, and may be used to control the functions of the boat.

To the left of the thumb is throttle down button 278. Resting above throttle down button 278 is reverse button 260. To the right of reverse button 260 is neutral button 262. Below neutral button 262 are four raised lines 264 reaching to the top of thumb rest 282. Four raised lines 264 indicate the location of neutral button 262 and serve to make less likely accidental upward movement by the user's thumb. To the right of neutral button 262 is forward button 266. Directly above neutral button 262 is tilt down button 268 for the outboard motor trim of a boat and above forward button 266 is tilt up button 270 for the outboard motor trim of a boat. To the right of thumb rest 282 is throttle up button 280.

Control panel 255 is similar in configuration to control panel 155 in the inventive navigation controller 110. Control panel 255 differs in configuration from control panel 155 in that control panel 255 has throttle up button 280, located to the right of user's thumb, and throttle down button 278, located to the left of user's thumb, on either side of ovular-shaped thumb rest 282. This is done because controller 210 is engaged by the user and directly allows the user to rotate or spend the steering wheel of the watercraft. Control panel 255 may also house all electronics, including actuation, transmitter, and power (including a battery for powering control electronics).

Adjacent thumb rest 282 is grip 240. Grip 240 comprises an ovular-shaped handhold 284, in which user can easily rest the user's thumb on thumb rest 282 and rest the remaining four fingers of the user's hand on handhold 284. Grip 240 also has a mounting support 286 that extends towards the wheel of a boat and is optionally a smaller dimension than handhold 284. At the end of mounting support 286 (FIG. 59), closest to the wheel, is threaded mounting member 288.

Threaded mounting member 288 (FIG. 60) is secured to a support member 289 which is rotatably mounted for rotation about an axis perpendicular to the plane of the steering wheel of the boat. This allows the user to engage top surface 211 with his or her palm and rotate the steering wheel in the matter in which a steering of his used to rotate a steering wheel and a car. The helical ridge of mounting stud 288 allows simple movement of the inventive spinner controller 210 to always face the user during movement of the wheel.

The user applies pressure to handhold 284 to control the direction of the wheel and, further, control the direction of the boat.

With respect to the above description, it is realized that the optimum dimensional relationships for parts of the invention, including variations in size, materials, shape, form, function, and manner of operation, assembly and use, are deemed readily apparent and obvious to one skilled in the art. All equivalent relationships to those illustrated in the drawings and described in the specification are intended to be encompassed by the present invention.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. A navigation controller for a watercraft powered by an engine, comprising:
(a) a grip member having a facing portion, and a reverse portion opposite said facing portion, said grip member being configured and dimensioned to be gripped by a hand of a user, so that, when the user is gripping the grip member, (i) the palm of the hand may engage the facing portion of the grip member, (ii) the tips of one or more of the fingers of the hand, other than the thumb, may simultaneously engage the reverse portion of the grip member and (iii) the thumb of the hand is free to perform another action;
(b) a control support secured to said grip member, said control support having a switch support portion; and
(c) a plurality of control switches for generating control output signals for controlling at least the speed of the watercraft, said control switches being positioned at points on the switch support portion of the control support, the location of said points allowing the user to simultaneously push one of said control switches with the thumb of the hand of the user while (i) the palm of the hand of the user overlies the facing portion of the grip member and (ii) the tips of one or more of the fingers of the hand engage the reverse portion of the grip member, whereby the user may securely grip the grip member while operating one or more of the control switches with the thumb of the hand gripping the grip member.

2. A navigation controller for a watercraft as in claim 1, further comprising
a mount for mounting the grip member to the watercraft, the grip member being mounted to be engagable by the hand of the user.

3. A navigation controller for a watercraft as in claim 1, further comprising
a mount for mounting the grip member to the watercraft, the grip member being mounted to be engagable by the hand of the user.

4. A navigation controller for a watercraft as in claim 1, wherein said switch support portion defines a thumb rest support portion, and a first of said control switches is positioned to the left of said thumb rest support portion and a second of said control switches is positioned to the right of said thumb rest support portion.

5. A navigation controller for a watercraft as in claim 4, further comprising three additional switches disposed on said switch support portion at distances displaced from said grip member greater than the distances at which said first of said control switches and said second of said control switches are displaced from said grip member, said three additional switches controlling the engine to operate in forward, reverse and neutral modes.

6. A navigation controller for a watercraft as in claim 5, wherein (i) a first one of said three additional switches is disposed to the left of said thumb rest support portion and when actuated puts said engine in reverse mode, (ii) a second one of said three additional switches is disposed to the right of said thumb rest support portion and when actuated puts said engine in forward mode, and (iii) a third one of said three additional switches is disposed between the first one of said three additional switches and the second one of said three additional switches and when actuated puts said engine in neutral mode.

7. A navigation controller for a watercraft as in claim 6, wherein said engine is an outboard engine, and further comprising two trim switches disposed on said switch support portion at distances displaced from said grip member greater than the distances at which said three additional switches are displaced from said grip member, said to trim switches controlling the angular position of said outboard engine.

8. A navigation controller for a watercraft as in claim 6, wherein said one of said speed control switches causing the engine to increase speed is displaced further from the grip member then the other of said speed control switches causing the engine to decrease speed, whereby the user may simultaneously actuate the speed control switch causing the engine to decrease speed while simultaneously actuating the third one of said three additional switches which when actuated puts said engine in neutral mode.

9. A navigation controller for a watercraft as in claim 2, wherein the watercraft has a steering wheel, and the mount for mounting the grip member to the watercraft is rotatably mounted on the steering wheel.

10. A navigation controller for a watercraft as in claim 9, wherein the control support has a switch support portion is oriented generally transversely to said facing portion.

11. A navigation controller for a watercraft as in claim 4, wherein said first of said control switches and said second of said control switches control the speed of the watercraft.

12. A navigation controller for a watercraft as in claim 1 further comprising a mount for mounting the grip member to a steering wheel of the watercraft, the grip member being rotatably mounted to be engagable by the hand of the user for rotating the steering wheel by the user to steer the watercraft, said control support supporting the control switches below the grip member, so that the steering of the watercraft is controlled by rotating the steering wheel through movement of the grip member by the user, while simultaneous activation of the control switches by the thumb of the same hand may be performed, wherein the control switches rotate with the grip member and remain accessible to the user while allowing a substantially unchanged orientation to the hand of the user during rotation of the steering wheel.

13. A navigation controller for a watercraft as in claim 2, wherein the watercraft has a steering wheel, and the switch support portion of the control support is oriented generally transversely to said facing portion.

14. A navigation controller for a watercraft as in claim 1, wherein said control switches generate control output signals for controlling at least the speed of the watercraft and the direction of the watercraft.

15. A navigation controller for a watercraft as in claim 1, wherein
said control support has an exposed switch support portion oriented generally in a plane extending in the same direction as said facing portion.

16. A navigation controller for a watercraft as in claim 15 wherein said control support has front side and an opposite side, and further comprising speed switches positioned on the opposite side of said control support, at positions which allow the index finger of the user to operate said speed switches while (i) the palm of the hand of the user overlies the facing portion of the grip member and (ii) the tips of one or more of the fingers of the hand engage the reverse portion of the grip member.

17. A navigation controller for a watercraft as in claim 4, wherein said first of said control switches and said second of said control switches control the direction of the watercraft.

18. A navigation controller for a watercraft as in claim 17, further comprising a pair of speed control switches positioned on a side of said control support opposite said exposed switch support portion, one of said speed control switches causing the engine to increase speed and the other of said speed control switches causing the engine to decrease speed.

19. A navigation controller for a watercraft as in claim 18, further comprising, further comprising three additional switches disposed on said switch support portion at distances displaced from said grip member greater than the distances at which said first of said control switches and said second of said control switches are displaced from said grip member, said three additional switches controlling the engine to operate in forward, reverse and neutral modes and wherein (i) a first one of said three additional switches is disposed to the left of said thumb rest support portion and when actuated puts said engine in reverse mode, (ii) a second one of said three additional switches is disposed to the right of said thumb rest support portion and when actuated puts said engine in forward mode, and (iii) a third one of said three additional switches is disposed between the first one of said three additional switches and the second one of said three additional switches and when actuated puts said engine in neutral mode and wherein said one of said speed control switches causing the engine to increase speed is displaced further from the grip member then the other of said speed control switches causing the engine to decrease speed, whereby the user may simultaneously actuate the speed control switch causing the engine to decrease speed while simultaneously actuating the third one of said three additional switches which when actuated puts said engine in neutral mode.

20. A navigation controller for a watercraft according to claim 1, further comprising a mount for mounting the grip member to a steering wheel of the watercraft, said mount comprising a clamp for removably clamping the grip member, control switches and control plate to the steering wheel.

21. A navigation controller for a watercraft according to claim 1, wherein the grip member is pivotally mounted on the mount to accommodate an angle of the steering wheel relative to a position of the user.

22. A navigation controller for a watercraft according to claim 1, wherein the mount includes position adjustment means for adjusting at least one of the angle, location and rotation of the grip member.

23. A navigation controller for a watercraft according to claim 1, wherein the control switches include a first set of control switches located on the control plate, the first set of control switches comprising at least a throttle up switch and a throttle down switch and wherein the control switches further include a second set of secondary control switches located on a switch support plate, the second set of control switches including at least one of a forward switch, a neutral switch, a reverse switch, a kill switch and a warm up switch.

24. A navigation controller for a watercraft according to claim 23, further comprising a switch activation sensitivity switch for controlling a rate of change of the navigation control of the watercraft associated with at least one of the control switches.

25. A navigation controller for a watercraft according to claim 1, wherein one or more of the control switches are piezoelectric switches.

26. A navigation controller for a watercraft as in claim 1, further comprising:
a mount attachable to the steering wheel of the watercraft, the mount being configured for retrofittably mounting the grip member to the steering wheel so that the grip member is engagable by the hand of the user for rotating the steering wheel by the user to steer the watercraft; and
a tactile location indicator positioned on the control plate, so that when not activating said control switch, the thumb or finger of the user can locate and rest on the tactile location indicator to facilitate quick locating of a particular control switch by the thumb or finger while the fingers remain engaged with the grip member while the fingers and thumb of the hand can develop the full grip on the grip member to provide the resistance to movement, wherein the control switches rotate with the grip member and remain visible to the user while constantly maintaining maintain a same orientation to the hand.

27. A navigation controller for a watercraft according to claim 26, wherein the control switches include a first set of control switches located on the control plate, the first set of control switches comprising at least a throttle up switch and a throttle down switch.

28. A navigation controller for a watercraft according to claim 27, further comprising a second set of control switches located on a first switch support plate, the second set of control switches may include at least one of a forward switch, a neutral switch, a reverse switch, a kill switch, engine tilt switch and a warm up switch, wherein the first switch support plate is mountable at a location on the steering wheel different from a location of the mount bed, wherein the control switches supported on the control plate maintain a constant orientation relative to the hand of the user.

29. A navigation controller for a watercraft according to claim 28, further comprising a third set of control switches located on a second switch support or plate, the third set of control switches including at least one of a forward switch, a neutral switch, a reverse switch, a kill switch, engine tilt switch and a warm up switch, wherein the second switch support plate is mountable at a location on the steering wheel different from the location of the first switch support plate and the location of the mount bed.

30. A navigation controller for a watercraft according to claim 1, wherein a tactile location indicator is positioned on the control support so that when not activating a control switch, the thumb rests on the tactile location indicator to facilitate quick locating of a particular control switch.

31. A navigation controller for a watercraft according to claim 30, wherein the tactile location indicator includes at least one of a textured surface and a vibrator for indicating when a switch has been activated.

32. A navigation controller for a watercraft according to claim 1, where the tactile location indicator includes a raised central resting pad.

33. A navigation controller for a watercraft according to claim 29, wherein the tactile location indicator is positioned on the control plate so that when not activating a control switch, the thumb rests on the tactile location indicator to facilitate quick locating of a particular control switch.

34. A navigation controller for a watercraft according to claim 33, wherein the tactile location indicator includes at least one of a textured surface and a vibrator for indicating when a switch has been activated.

35. A navigation controller for a watercraft, comprising:
a grip member configured and dimensioned to be grabbed by a hand of a user so that when gripping the grip member the palm of the hand may engage the top of the grip member and the tips of the fingers may simultaneously engage the bottom of the grip member and the thumb of the hand is free to perform another action;
a mount for mounting the grip member to a steering wheel of the watercraft, the grip member being rotatably mounted to be engagable by the hand of the user for rotating the steering wheel by the user to steer the watercraft;
control switches for generating control output signals for controlling at least the speed of the watercraft; and
a control support supporting the control switches below the grip member and rotatably mounted with the grip member and positioned, configured and dimensioned relative to the grip member to enable a thumb of the user to engage with one or more of the control switches while the fingers of the same hand remains engaged with the grip member so that the steering of the watercraft is controlled by rotating the steering wheel through movement of the grip member by the user while simultaneous activation of the control switches by the thumb of the same hand may be performed, wherein the control switches rotate with the grip member and remain visible to the user while constantly maintaining a same orientation to the hand.

36. A navigation controller for a watercraft as in claim 1, wherein said control support has front side and an opposite side, and further comprising speed switches positioned on the opposite side of said control support, at positions which allow the index finger of the user to operate said speed switches while (i) the palm of the hand of the user overlies the facing portion of the grip member and (ii) the tips of one or more of the fingers of the hand engage the reverse portion of the grip member.
